(19) United States
(12) Patent Application Publication
(10) Pub. No.: US 2024/0120981 A1
(43) Pub. Date: Apr. 11, 2024

(54) METHOD AND DEVICE IN NODES USED FOR WIRELESS COMMUNICATION

(71) Applicants: Keying WU, Shanghai (CN); Xiaobo ZHANG, Shanghai (CN)

(72) Inventors: Keying WU, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/544,472

(22) Filed: Dec. 19, 2023

Related U.S. Application Data
(63) Continuation of application No. PCT/CN2022/100954, filed on Jun. 24, 2022.

(30) Foreign Application Priority Data
Jun. 30, 2021 (CN) 202110732580.3
Jul. 9, 2021 (CN) 202110779267.5

(51) Int. Cl. H04B 7/06; H04L 5/00

(52) U.S. Cl. CPC H04B 7/0658; H04B 7/0626; H04L 5/0051

(57) ABSTRACT

The present application discloses a method and device in a node for wireless communications. A first node receives a reference signal in a first reference signal resource sub-pool; determines a first function according to the receiving behavior in the first reference signal resource sub-pool; transmits a first information block, the first information block being used to determine the first function; receives a second information block, the second information block being used to determine whether a target reference signal resource is associated with the first function; and transmits a third information block, the third information block indicating a first compressed CSI, the first compressed CSI being an input to the first function for generating a first CSI. The method above can configure relations between reference signals and AI algorithms/parameters flexibly to choose an optimal AI algorithm/parameter for compressing/decompressing CSI based on a reference signal, thus optimizing the CSI feedback performance.

### CROSS REFERENCE TO RELATED APPLICATIONS

This application is the continuation of the international patent application No. PCT/CN2022/100954, filed on Jun. 24, 2022, and claims the priority benefit of Chinese Patent Application No. 202110732580.3, filed on Jun. 30, 2021, and claims the priority benefit of Chinese Patent Application No. 202110779267.5, filed on Jul. 9, 2021, the full disclosure of which is incorporated herein by reference.

### BACKGROUND

### Technical Field

The present application relates to transmission methods and devices in wireless communication systems, and in particular to a method and device for radio signal transmission in a wireless communication system supporting cellular networks.

### Related Art

The Multi-antenna technique is a crucial part in the 3rd Generation Partner Project (3GPP) Long-term Evolution (LTE) and New Radio (NR) systems. More than one antenna can be configured, at the communication node, e.g., a base station or a User Equipment (UE), to obtain extra degree of freedom in space. Through multi-antenna processing like precoding and/or beamforming, multiple antennas form a beam pointing in a specific direction to enhance the communication quality. In a downlink multi-antenna transmission, a User Equipment (UE) generally has to feedback Channel State Information (CSI) for assisting a base station in performing precoding and/or beamforming. With the increase of the number of antennas, the overhead of CSI feedback is getting larger. And the applications of various enhanced multi-antenna techniques, such as multi-user MIMO, are posing higher demands on the accuracy of feedback, which will further raise the feedback overhead.

The application of Machine Learning (ML)/Artificial Intelligence (AI) in physical layers of wireless communication systems has drawn attention and sparked discussions extensively at the 3GPP RAN #88e conference and 3GPP R (release) 18 workshops. It is generally considered that using ML/AI for CSI compression as a solution to both the accuracy and overhead of CSI feedback is one of the most important applications of ML/AI in the physical layer.

### SUMMARY

In AI algorithm, training is a very important procedure that will directly influence the performance of AI algorithm. The applicant finds through researches that reference signals subjected to beamforming by different beams have different requirements for the training procedure of AI. And different performances can be obtained by compressing CSIs obtained based on different reference signals with a same group of AI parameters derived from training. Then how to adapt reference signals to AI algorithms/parameters to optimize the CSI feedback performance becomes a problem in need of solving.

To address the above problem, the present application provides a solution. It should be noted that although the description above only took cellular networks as an example, the present application also applies to other scenarios like Vehicle-to-Everything (V2X) and sidelink transmission, where similar technical effects can be achieved. Additionally, the adoption of a unified solution for various scenarios, including but not limited to cellular networks, V2X and sidelink transmission, contributes to the reduction of hardcore complexity and costs. In the case of no conflict, the embodiments of a first node and the characteristics in the embodiments may be applied to a second node, and vice versa. What's more, the embodiments in the present application and the characteristics in the embodiments can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:
receiving a reference signal in a first reference signal resource sub-pool, the first reference signal resource sub-pool comprising at least one reference signal resource; and
determining a first function according to the receiving behavior in the first reference signal resource sub-pool; and
transmitting a first information block, the first information block being used to determine the first function; and
receiving a second information block, the second information block being used to determine whether a target reference signal resource is associated with the first function; and
transmitting a third information block, the third information block indicating a first compressed CSI, the first compressed CSI being an input to the first function for generating a first CSI.

In one embodiment, a problem to be solved in the present application includes: how to adapt reference signals to AI algorithms/parameters to optimize the CSI feedback performance.

In one embodiment, characteristics of the above method include: the first function contains one type of AI algorithm and a group of parameters to be used for the AI algorithm obtained through training; the second information block indicates whether a CSI obtained for the target reference signal resource is compressed/decompressed by the first function.

In one embodiment, an advantage of the above method includes: by configuring the relation between reference signals and AI algorithms/parameters in a flexible manner, the optimal AI algorithm/parameter is chosen to compress/decompress a CSI based on a reference signal, so that the performance of CSI feedback can be optimized.

According to one aspect of the present application, characterized in comprising:
determining a second function according to the receiving behavior in the first reference signal resource sub-pool;
herein, an output of the second function comprises the first compressed CSI.

According to one aspect of the present application, characterized in comprising:
transmitting a fourth information block, the fourth information block indicating a second compressed CSI, the second compressed CSI being an input to a first enhancement function for generating a second CSI;
herein, the first function is used for generating the first enhancement function; the second information block is used to determine whether the target reference signal resource is associated with the first enhancement function.

In one embodiment, an advantage of the above method includes: using AI algorithms at different levels of complexity for performing compression/decompression processing on CSIs based on different reference signals, reaching a balance between the complexity and the performance of algorithms/training.

According to one aspect of the present application, characterized in that the second information block indicates at least part of characteristics of the first function.

According to one aspect of the present application, characterized in that the second information block indicates at least part of characteristics of the first enhancement function.

According to one aspect of the present application, characterized in that the second information block comprises a first transmission configuration state, the first transmission configuration state implicitly indicating whether the target reference signal resource is associated with the first function.

In one embodiment, an advantage of the above method includes: indicating the relation between reference signals and AI algorithm/parameters implicitly, which reduces the signaling overhead.

According to one aspect of the present application, characterized in comprising:
transmitting a fifth information block, the fifth information block indicating whether the target reference signal resource is suitable to be associated with the first function.

In one embodiment, an advantage of the above method includes: allowing the UE to adjust the corresponding relationship between reference signals indicated by the base station and AI algorithms/parameters, which further optimizes the degree of matching between reference signals and AI algorithm/parameters, hence an optimized performance of CSI feedback.

According to one aspect of the present application, the first node is a UE.

According to one aspect of the present application, the first node is a relay node.

The present application provides a method in a second node for wireless communications, comprising:
transmitting a reference signal in a first reference signal resource sub-pool, the first reference signal resource sub-pool comprising at least one reference signal resource, and a target receiver of the first reference signal resource sub-pool determining a first function according to the receiving behavior in the first reference signal resource sub-pool; and
receiving a first information block, the first information block being used to determine the first function; and
transmitting a second information block, the second information block being used to determine whether a target reference signal resource is associated with the first function; and
receiving a third information block, the third information block indicating a first compressed CSI, the first compressed CSI being an input to the first function for generating a first CSI.

According to one aspect of the present application, characterized in that the target receiver of the first
reference signal resource sub-pool determines a second function according to the receiving behavior in the first reference signal resource sub-pool; herein, an output of the second function comprises the first compressed CSI.

According to one aspect of the present application, characterized in comprising:
receiving a fourth information block, the fourth information block indicating a second compressed CSI, the second compressed CSI being an input to a first enhancement function for generating a second CSI;
herein, the first function is used for generating the first enhancement function; the second information block is used to determine whether the target reference signal resource is associated with the first enhancement function.

According to one aspect of the present application, characterized in that the second information block indicates at least part of characteristics of the first function.

According to one aspect of the present application, characterized in that the second information block indicates at least part of characteristics of the first enhancement function.

According to one aspect of the present application, characterized in that the second information block comprises a first transmission configuration state, the first transmission configuration state implicitly indicating whether the target reference signal resource is associated with the first function.

According to one aspect of the present application, characterized in comprising:
receiving a fifth information block, the fifth information block indicating whether the target reference signal resource is suitable to be associated with the first function.

According to one aspect of the present application, the second node is a base station.

According to one aspect of the present application, the second node is a UE.

According to one aspect of the present application, the second node is a relay node.

The present application provides a first node for wireless communications, comprising:
a first processor, which receives a reference signal in a first reference signal resource sub-pool, the first reference signal resource sub-pool comprising at least one reference signal resource, and determines a first function according to the receiving behavior in the first reference signal resource sub-pool; and a first transmitter, which transmits a first information block, the first information block being used to determine the first function;
the first processor, which receives a second information block, the second information block being used to determine whether a target reference signal resource is associated with the first function;
the first transmitter, which transmits a third information block, the third information block indicating a first compressed CSI, the first compressed CSI being an input to the first function for generating a first CSI.

The present application provides a second node for wireless communications, comprising:
a second transmitter, which transmits a reference signal in a first reference signal resource sub-pool, the first reference signal resource sub-pool comprising at least one reference signal resource, and a target receiver of the first reference signal resource sub-pool determining a first function according to the receiving behavior in the first reference signal resource sub-pool; and
a first receiver, which receives a first information block, the first information block being used to determine the first function;
the second transmitter, which transmits a second information block, the second information block being used to determine whether a target reference signal resource is associated with the first function;
the first receiver, which receives a third information block, the third information block indicating a first compressed CSI, the first compressed CSI being an input to the first function for generating a first CSI.

In one embodiment, compared with the prior art, the present application is advantageous in the following aspects:
by configuring the relation between reference signals and AI algorithms/parameters in a flexible manner, the optimal AI algorithm/parameter is chosen to compress/decompress a CSI based on a reference signal, so that the performance of CSI feedback can be optimized.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of a first reference signal resource sub-pool, a first function, a first information block, a second information block and a third information block according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of transmission according to one embodiment of the present application.

FIG. 6 illustrates a schematic diagram of a relation between a first CSI and a first compressed CSI according to one embodiment of the present application.

FIG. 7 illustrates a schematic diagram of a first function according to one embodiment of the present application.

FIG. 8 illustrates a schematic diagram of a second function according to one embodiment of the present application.

FIG. 9 illustrates a schematic diagram of relations among a first CSI, a first compressed CSI, a first function and a second function according to one embodiment of the present application.

FIG. 10 illustrates a schematic diagram of a first enhancement function according to one embodiment of the present application.

FIG. 11 illustrates a schematic diagram of a second enhancement function according to one embodiment of the present application.

FIG. 12 illustrates a schematic diagram of relations among a second CSI, a second compressed CSI, a first enhancement function and a second enhancement function according to one embodiment of the present application.

FIG. 13 illustrates a schematic diagram of a second information block indicating at least part of characteristics of a first function according to one embodiment of the present application.

FIG. 14 illustrates a schematic diagram of a second information block indicating at least part of characteristics of a first enhancement function according to one embodiment of the present application.

FIG. 15 illustrates a schematic diagram of a first transmission configuration state implicitly indicating whether a target reference signal resource is associated with a first function according to one embodiment of the present application.

FIG. 16 illustrates a schematic diagram of a fifth information block indicating whether a target reference signal resource is suitable to be associated with a first function according to one embodiment of the present application.

FIG. 17 illustrates a structure block diagram of a processing device in a first node according to one embodiment of the present application.

FIG. 18 illustrates a structure block diagram a processing device in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

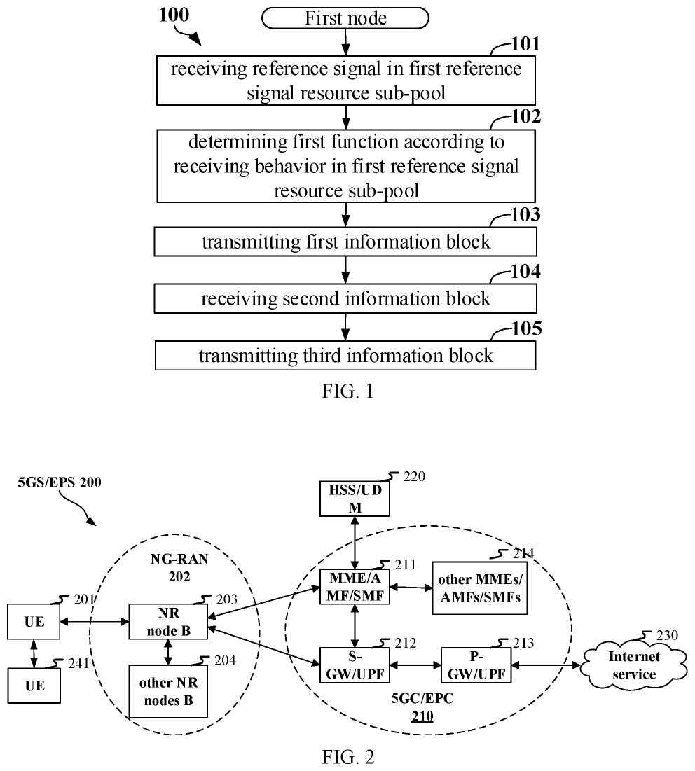

Embodiment 1 illustrates a flowchart of a first reference signal resource sub-pool, a first function, a first information block, a second information block and a third information block according to one embodiment of the present application, as shown in FIG. 1. In 100 illustrated by FIG. 1, each box represents a step. Particularly, the sequential step arrangement in each box herein does not imply a chronological order of steps marked respectively by these boxes.

In Embodiment 1, the first node in the present application receives a reference signal in a first reference signal resource sub-pool in step 101, the first reference signal resource sub-pool comprising at least one reference signal resource; and determines a first function according to the receiving behavior in the first reference signal resource sub-pool in step 102; and transmits a first information block in step 103, the first information block being used to determine the first function; and receives a second information block in step 104, the second information block being used to determine whether a target reference signal resource is associated with the first function; and transmits a third information block in step 105, the third information block indicating a first compressed CSI, the first compressed CSI being an input to the first function for generating a first CSI.

In one embodiment, the first reference signal resource sub-pool comprises multiple reference signal resources.

In one embodiment, the first reference signal resource sub-pool only comprises one reference signal resource.

In one embodiment, there is one reference signal resource in the first reference signal resource sub-pool that comprises a Channel State Information-Reference Signal (CSI-RS) resource.

In one embodiment, any reference signal resource in the first reference signal resource sub-pool is a CSI-RS resource.

In one embodiment, there is one reference signal resource in the first reference signal resource sub-pool that comprises a Synchronisation Signal (SS)/physical broadcast channel (PBCH) Block resource.

In one embodiment, any reference signal resource in the first reference signal resource sub-pool is a CSI-RS resource or a SS/PBCH Block resource.

In one embodiment, any reference signal resource in the first reference signal resource sub-pool comprises a Sounding Reference Signal (SRS) resource.

In one embodiment, there is one reference signal resource in the first reference signal resource sub-pool that comprises a DeModulation Reference Signal (DMRS) port.

In one embodiment, there is one reference signal resource in the first reference signal resource sub-pool that comprises a Phase-Tracking Reference Signal (PTRS) port.

In one embodiment, any reference signal resource in the first reference signal resource sub-pool comprises at least one RS port.

In one embodiment, the RS port(s) includes/include a CSI-RS port.

In one embodiment, the RS port(s) includes/include an antenna port.

In one embodiment, the RS port(s) includes/include at least one of a DMRS port, a PTRS port or an SRS port.

In one embodiment, any reference signal resource in the first reference signal resource sub-pool corresponds to a first-type index, the first-type index being a non-negative integer; first-type indexes corresponding to any two reference signal resources in the first reference signal resource sub-pool are of equal value.

In one embodiment, reference signal resources in the first reference signal resource sub-pool belong to a same carrier.

In one embodiment, reference signal resources in the first reference signal resource sub-pool belong to a same BandWidth Part (BWP).

In one embodiment, reference signal resources in the first reference signal resource sub-pool belong to a same serving cell.

In one embodiment, there are two reference signal resources in the first reference signal resource sub-pool that belong to different carriers.

In one embodiment, there are two reference signal resources in the first reference signal resource sub-pool that belong to different BWPs.

In one embodiment, there are two reference signal resources in the first reference signal resource sub-pool that belong to different serving cells.

In one embodiment, there is one reference signal resource being aperiodic in the first reference signal resource sub-pool.

In one embodiment, there is one reference signal resource being periodic in the first reference signal resource sub-pool.

In one embodiment, the second information block indicates a first reference signal resource pool, and any reference signal resource in the first reference signal resource sub-pool belongs to the first reference signal resource pool, the first reference signal resource pool comprising at least one reference signal resource; the first node determines the first function according to a reference signal received in reference signal resource(s) in the first reference signal resource pool.

In one embodiment, the first information block indicates the first function.

In one embodiment, the first information block indicates the first function determined according to the receiving behavior in the first reference signal resource sub-pool.

In one embodiment, the first information block is carried by a higher layer signaling.

In one embodiment, the first information block is carried by a Radio Resource Control (RRC) signaling.

In one embodiment, the first information block is carried by a Medium Access Control layer Control Element (MAC CE).

In one embodiment, the first information block is carried by a physical layer signaling.

In one embodiment, the first information block comprises information in all or part of fields in an Information Element (IE).

In one embodiment, the first information block is carried by a MeasurementReport message.

In one embodiment, the first information block is carried by a Layer 3 (L3) signaling.

In one embodiment, a channel occupied by the first information block includes a Physical Uplink SharedCHannel (PUSCH).

In one embodiment, a channel occupied by the first information block includes a Physical Uplink Control Channel (PUCCH).

In one embodiment, a channel occupied by the first information block includes an Uplink Shared Channel (UL-SCH).

In one embodiment, the second information block is carried by a higher layer signaling.

In one embodiment, the second information block is carried by an RRC signaling.

In one embodiment, the second information block is carried by a MAC CE.

In one embodiment, the second information block is carried by a physical layer signaling.

In one embodiment, the second information block is carried by an RRC signaling and a MAC CE together.

In one embodiment, the second information block is carried by an RRC signaling and a physical layer signaling together.

In one embodiment, the second information block is carried by an IE.

In one embodiment, a name of an IE carrying the second information block includes “CSI-ReportConfig”.

In one embodiment, a name of an IE carrying the second information block includes “CSI-ResourceConfig”.

In one embodiment, a name of an IE carrying the second information block includes “CSI-MeasConfig”.

In one embodiment, a name of an IE carrying the second information block includes “NZP-CSI-RS-Resource”.

In one embodiment, the second information block is earlier than the first information block in time domain.

In one embodiment, the target reference signal resource comprises a CSI-RS resource.

In one embodiment, the target reference signal resource is a CSI-RS resource.

In one embodiment, the target reference signal resource comprises a SS/PBCH Block resource.

In one embodiment, the target reference signal resource is a CSI-RS resource or a SS/PBCH Block resource.

In one embodiment, the target reference signal resource comprises an SRS resource.

In one embodiment, the target reference signal resource comprises a DMRS port.

In one embodiment, the target reference signal resource comprises a PTRS port.

In one embodiment, the target reference signal resource comprises at least one RS port.

In one embodiment, the target reference signal resource is aperiodic.

In one embodiment, the target reference signal resource is periodic.

In one embodiment, an occurrence of the target reference signal resource in time domain is earlier than the second information block.

In one embodiment, an occurrence of the target reference signal resource in time domain is later than the second information block.

In one embodiment, there is one reference signal resource in the first reference signal resource sub-pool of which an occurrence in time domain is earlier than one occurrence of the target reference signal resource in time domain.

In one embodiment, there is one reference signal resource in the first reference signal resource sub-pool of which an occurrence in time domain is later than one occurrence of the target reference signal resource in time domain.

In one embodiment, the first reference signal resource sub-pool comprises the target reference signal resource.

In one embodiment, the first reference signal resource sub-pool does not comprise the target reference signal resource.

In one embodiment, the second information block indicates the target reference signal resource.

In one embodiment, the second information block indicates configuration information of the target reference signal resource.

In one embodiment, the configuration information of the target reference signal resource comprises part or all of time-domain resources, frequency-domain resources, a Code Division Multiplexing type (cdm-type), a CDM group, scrambling, periodicity, a slot offset, a Quasi Co-Location (QCL) relation, density or a number of RS ports.

In one embodiment, the second information block indicates an identity of the target reference signal resource.

In one embodiment, an identity of the target reference signal resource includes an NZP-CSI-RS-ResourceId or an SSB-Index.

In one embodiment, the second information block indicates whether the target reference signal resource is associated with the first function.

In one embodiment, the second information block indicates that the target reference signal resource is associated with the first function.

In one embodiment, the second information block indicates that the target reference signal resource is not associated with the first function.

In one embodiment, the second information block explicitly indicates whether the target reference signal resource is associated with the first function.

In one embodiment, the second information block comprises a first bit field, the first bit field comprising at least one bit; a value of the first bit field indicates whether the target reference signal resource is associated with the first function.

In one embodiment, the second information block implicitly indicates whether the target reference signal resource is associated with the first function.

In one embodiment, the configuration information of the target reference signal resource implicitly indicates whether the target reference signal resource is associated with the first function.

In one embodiment, time-frequency resources occupied by the target reference signal resource are used to determine whether the target reference signal resource is associated with the first function.

In one embodiment, at least one of a cdm-type or a CDM group of the target reference signal resource is used to determine whether the target reference signal resource is associated with the first function.

In one embodiment, a QCL relation of the target reference signal resource is used to determine whether the target reference signal resource is associated with the first function.

In one embodiment, a number of RS ports of the target reference signal resource is used to determine whether the target reference signal resource is associated with the first function.

In one embodiment, the target reference signal resource belongs to the first reference signal resource sub-pool, and the second information block indicates which reference signal resource(s) in the first reference signal resource sub-pool is(are) associated with the first function.

In one embodiment, the first function is one of M1 functions, M1 being a positive integer greater than 1; the second information block indicates whether the target reference signal resource is associated with one of the M1 functions; when the second information block indicates that the target reference signal resource is associated with one of the M1 functions, the second information block indicates which one of the M1 functions the target reference signal resource is associated with.

In one subembodiment, the M1 functions are non-linear, respectively.

In one subembodiment, any of the M1 functions comprises a decoder of Neural Networks for CSI compression.

In one subembodiment, any two different functions among the M1 functions are different in at least one of a convolutional kernel, a convolutional kernel size, a number of convolution layers, a convolution step, pooling function, a pooling kernel size, a step of pooling kernel, pooling function parameters, activation function, a threshold of activation function, a number of feature maps or weights between feature maps comprised respectively.

In one embodiment, when the second information block indicates that the target reference signal resource is associated with the first function, the second information block also indicates which RS port(s) of the target reference signal resource is(are) associated with the first function.

In one embodiment, when the target reference signal resource is associated with the first function, all RS ports of the target reference signal resource are associated with the first function.

In one embodiment, when the target reference signal resource is associated with the first function, all RS ports or only part of ports of the target reference signal resource are associated with the first function.

In one embodiment, the meaning of the phrase that the target reference signal resource is associated with the first function includes: a CSI obtained based on a channel measurement of a reference signal received in the target reference signal resource will be used as an input to the first function.

In one subembodiment, the CSI comprises a compressed CSI.

In one embodiment, the meaning of the phrase that the target reference signal resource is associated with the first function includes: the first node will obtain a channel measurement for calculating an input to the first function based on a reference signal received in the target reference signal resource.

In one embodiment, the meaning of the phrase that the target reference signal resource is associated with the first function includes: the first function will be used for resuming a CSI obtained based on a channel measurement of a reference signal received in the target reference signal resource.

In one embodiment, the meaning of the phrase that the target reference signal resource is associated with the first function includes: the first function will be used for resuming information of a channel over which a reference signal received in the target reference signal resource is conveyed.

In one embodiment, the meaning of the phrase that the target reference signal resource is not associated with the first function includes: a CSI obtained based on a channel measurement of a reference signal received in the target reference signal resource is not used as an input to the first function.

In one subembodiment, the CSI comprises a compressed CSI.

In one embodiment, the meaning of the phrase that the target reference signal resource is not associated with the first function includes: the first node will not obtain a channel measurement for calculating an input to the first function based on a reference signal received in the target reference signal resource.

In one embodiment, the meaning of the phrase that the target reference signal resource is not associated with the first function includes: the first function is not used for resuming a CSI obtained based on a channel measurement of a reference signal received in the target reference signal resource.

In one embodiment, the meaning of the phrase that the target reference signal resource is not associated with the first function includes: the first function is not used for resuming information of a channel over which a reference signal received in the target reference signal resource is conveyed.

In one embodiment, if the target reference signal resource is not associated with the first function, a measurement of a reference signal received in the target reference signal resource is not used for generating the first compressed CSI.

In one embodiment, if the target reference signal resource is not associated with the first function, the first node does not obtain a channel measurement for calculating the first compressed CSI based on a reference signal received in the target reference signal resource.

In one embodiment, if only part of RS ports of the target reference signal resource are associated with the first function, the first node will obtain a channel measurement for calculating an input to the first function only based on a reference signal received on the part of RS ports.

In one embodiment, if only part of RS ports of the target reference signal resource are associated with the first function, the first function will be used only for recovering information of a channel over which a reference signal received on the part of RS ports is conveyed.

In one embodiment, if only part of RS ports of the target reference signal resource are associated with the first function, the first function will be used only for recovering a CSI obtained based on a channel measurement of a reference signal received on the part of RS ports.

In one embodiment, the third information block is borne by a physical layer signaling.

In one embodiment, the third information block is borne by a MAC CE signaling.

In one embodiment, the third information block comprises Channel state information (CSI).

In one embodiment, the CSI refers to Channel State Information.

In one embodiment, the CSI comprises a channel matrix.

In one embodiment, the CSI comprises information of a channel matrix.

In one embodiment, the CSI comprises information of amplitudes and phases of elements in a channel matrix.

In one embodiment, a measurement of a reference signal received in the first reference signal resource sub-pool is used for generating the first compressed CSI.

In one embodiment, the first node obtains a channel measurement for generating the first compressed CSI based on a reference signal received in the first reference signal resource sub-pool.

In one embodiment, the first compressed CSI is unrelated to a measurement of a reference signal received in the first reference signal resource sub-pool.

In one embodiment, the second information block indicates that the target reference signal resource is associated with the first function, and a measurement of a reference signal received in the target reference signal resource is used for generating the first compressed CSI.

In one embodiment, the second information block indicates that the target reference signal resource is associated with the first function, and the first node obtains a channel measurement for generating the first compressed CSI based on a reference signal received in the target reference signal resource.

In one embodiment, the first compressed CSI is unrelated to a measurement of a reference signal received in the target reference signal resource.

In one embodiment, the second information block indicates that the target reference signal resource is not associated with the first function, and the first compressed CSI is unrelated to a measurement of a reference signal received in the target reference signal resource.

In one embodiment, the second information block indicates that a measurement of a reference signal received in the target reference signal resource is not suitable to be used for generating a compressed CSI.

In one embodiment, the second information block indicates that a measurement of a reference signal received in the target reference signal resource is not used for generating a compressed CSI.

In one embodiment, the second information block indicates that the first node does not obtain a channel measurement for generating a compressed CSI based on a reference signal received in the target reference signal resource.

### Embodiment 2

Embodiment 2 illustrates a schematic diagram of a network architecture according to one embodiment of the present application, as shown in FIG. 2.

FIG. 2 is a diagram illustrating a network architecture of Long-Term Evolution (LTE), Long-Term Evolution Advanced (LTE-A) and future 5G systems. The LTE, or LTE-A or future 5G network architecture 200 may be called an Evolved Packet System (EPS) 200. The 5G NR or LTE network 200 can be called a 5G System/Evolved Packet System (5GS/EPS) 200 or other appropriate terms. The 5GS/EPS 200 may comprise one or more UEs 201, a UE 241 in sidelink communication with the UE(s) 201, an NG-RAN 202, a 5G CoreNetwork/Evolved Packet Core (5GC/EPC) 210, a Home Subscriber Server/Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services or other cellular networks. The NG-RAN 202 comprises a New Radio (NR) node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5G-CN/EPC 210 for the UE 201. Examples of UE 201 include cellular phones, smart phones, Session Initiation Protocol (SIP) phones, laptop computers, Personal Digital Assistant (PDA), Satellite Radios, Global Positioning System (GPS), multimedia devices, video devices, digital audio players (for example, MP3 players), cameras, games consoles, unmanned aerial vehicles, air vehicles, narrow-band physical network equipment, machine-type communication equipment, land vehicles, automobiles, wearables, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected with the 5G-CN/EPC 210 via an S1/NG interface. The 5G-CN/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching (PS) services.

In one embodiment, the first node in the present application includes the UE 201.

In one embodiment, the second node in the present application includes the gNB203.

In one embodiment, a radio link between the UE201 and the gNB203 is a cellular link.

In one embodiment, a transmitter of a reference signal in the first reference signal resource sub-pool includes the gNB203.

In one embodiment, a receiver of a reference signal in the first reference signal resource sub-pool includes the UE201.

In one embodiment, a transmitter of the first information block includes the UE201.

In one embodiment, a receiver of the first information block includes the gNB203.

In one embodiment, a transmitter of the second information block includes the gNB203.

In one embodiment, a receiver of the second information block includes the UE201.

In one embodiment, a transmitter of the third information block includes the UE201.

In one embodiment, a receiver of the third information block includes the gNB203.

In one embodiment, the UE201 supports the determination of at least part of parameters of Conventional Neural Networks (CNN) for CSI reconstruction through training.

### Embodiment 3

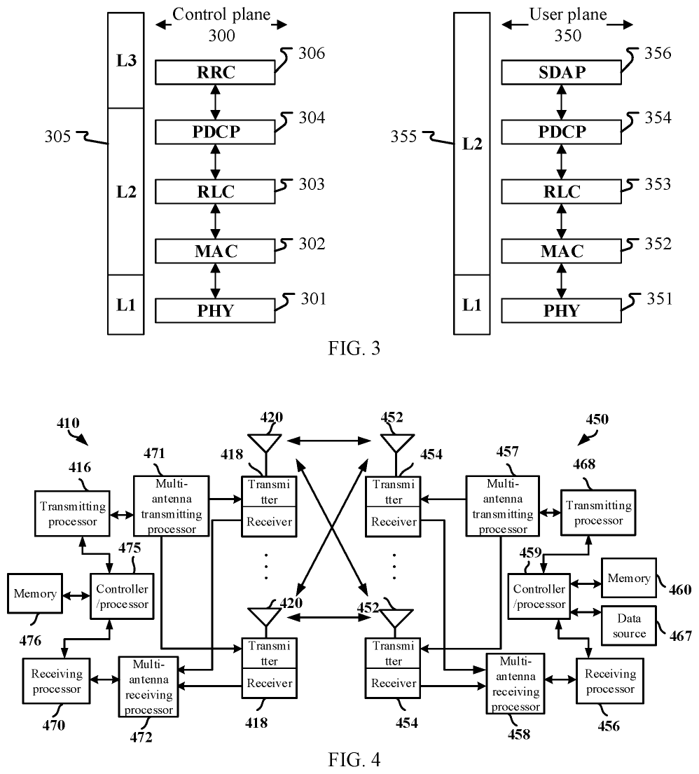

Embodiment 3 illustrates a schematic diagram of an example of a radio protocol architecture of a user plane and a control plane according to the present application, as shown in FIG. 3.

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first communication node (UE, gNB or, RSU in V2X) and a second communication node (gNB, UE, or RSU in V2X), or between two UEs, is represented by three layers, which are a layer 1, a layer 2 and a layer 3, respectively. The layer 1 (L1) is the lowest layer which performs signal processing functions of various PHY layers. The L1 is called PHY 301 in the present application. The layer 2 (L2) 305 is above the PHY 301, and is in charge of the link between the first communication node and the second communication node or between two UEs. The L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication nodes of the network side. The PDCP sublayer 304 provides multiplexing among variable radio bearers and logical channels. The PDCP sublayer 304 provides security by encrypting a packet and provides support for handover of a first communication node between second communication nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling between the second communication node and the first communication node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first communication node may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, a reference signal in the first reference signal resource sub-pool is generated by the PHY 301, or the PHY 351.

In one embodiment, the first information block is generated by the PHY 301, or the PHY 351.

In one embodiment, the first information block is generated by the MAC sublayer 302, or the MAC sublayer 352.

In one embodiment, the first information block is generated by the RRC sublayer 306.

In one embodiment, the second information block is generated by the MAC sublayer 302, or the MAC sublayer 352.

In one embodiment, the second information block is generated by the RRC sublayer 306.

In one embodiment, the third information block is generated by the PHY 301, or the PHY 351.

### Embodiment 4

Embodiment 4 illustrates a schematic diagram of a first communication device and a second communication device according to one embodiment of the present application, as shown in FIG. 4. FIG. 4 is a block diagram of a first communication device 410 and a second communication device 450 in communication with each other in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from a core network is provided to the controller/processor 475. The controller/processor 475 provides functions of the L2 layer. In DL, the controller/processor 475 provides header compression, encryption, packet segmentation and reordering, multiplexing between a logical channel and a transport channel and radio resource allocation of the second communication device 450 based on various priorities. The controller/processor 475 is responsible for HARQ operation, retransmission of a lost packet and a signaling to the second communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 450 side and the constellation mapping corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more parallel streams. The transmitting processor 416 then maps each parallel stream into a subcarrier. The modulated symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts baseband multicarrier symbol streams which have gone through reception analog precoding/beamforming operations from time domain to frequency domain using FFT. In frequency domain, physical layer data signals and reference signals are de-multiplexed by the receiving processor 456, where the reference signals are used for channel estimation while data signals are processed in the multi-antenna receiving processor 458 by multi-antenna detection to recover any parallel stream targeting the second communication device 450. Symbols on each parallel stream are demodulated and recovered in the receiving processor 456 to generate a soft decision. Then the receiving processor 456 decodes and de-interleaves the soft decision to recover the higher-layer data and control signal transmitted by the first communication device 410 on the physical channel. Next, the higher-layer data and control signal are provided to the controller/processor 459. The controller/processor 459 provides functions of the L2 layer. The controller/processor 459 can be associated with a memory 460 that stores program code and data. The memory 460 can be called a computer readable medium. In DL transmission, the controller/processor 459 provides de-multiplexing between a transport channel and a logical channel, packet reassembling, decryption, header decompression, control signal processing so as to recover a higher-layer packet from the core network. The higher-layer packet is later provided to all protocol layers above the L2 layer. Or various control signals can be provided to the L3 for processing. The controller/processor 459 is also in charge of using ACK and/or NACK protocols for error detection as a way to support HARQ operation.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in DL, the controller/processor 459 performs header compression, encryption, packet segmentation and reordering, and multiplexing between a logical channel and a transport channel based on radio resource allocation for the first communication device 410 so as to provide the L2 layer functions used for the user plane and the control plane. The controller/processor 459 is responsible for HARQ operation, retransmission of a lost packet and a signaling to the first communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated parallel streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data. The memory 476 can be called a computer readable medium. The controller/processor 475 provides demultiplexing between a transport channel and a logical channel, packet reassembling, decryption, header decompression and control signal processing so as to recover a higher-layer packet from the second communication device 450. The higher-layer packet coming from the controller/processor 475 may be provided to the core network. The controller/processor 475 can also perform error detection using ACK and/or NACK protocols to support HARQ operation.

In one embodiment, the second communication device 450 comprises at least one processor and at least one memory, the at least one memory comprises computer program codes; the at least one memory and the computer program codes are configured to be used in collaboration with the at least one processor. The second communication device 450 at least: receives a reference signal in the first reference signal resource sub-pool; and determines the first function according to the receiving behavior in the first reference signal resource sub-pool; and transmits the first information block; and receives the second information block; and transmits the third information block.

In one embodiment, the second communication device 450 comprises a memory that stores a computer readable instruction program, the computer readable instruction program generates actions when executed by at least one processor, which include: receiving a reference signal in the first reference signal resource sub-pool; and determining the first function according to the receiving behavior in the first reference signal resource sub-pool; and transmitting the first information block; and receiving the second information block; and transmitting the third information block.

In one embodiment, the first communication device 410 comprises at least one processor and at least one memory, the at least one memory comprises computer program codes; the at least one memory and the computer program codes are configured to be used in collaboration with the at least one processor. The first communication device 410 at least: transmits a reference signal in the first reference signal resource sub-pool; and receives the first information block; and transmits the second information block; and receives the third information block.

In one embodiment, the first communication device 410 comprises a memory that stores a computer readable instruction program, the computer readable instruction program generates actions when executed by at least one processor, which include: transmitting a reference signal in the first reference signal resource sub-pool; and receiving the first information block; and transmitting the second information block; and receiving the third information block.

In one embodiment, the first node in the present application comprises the second communication device 450.

In one embodiment, the second node in the present application comprises the first communication device 410.

In one embodiment, at least one of the antenna 452, the receiver 454, the receiving processor 456, the multi-antenna receiving processor 458, the controller/processor 459, the memory 460 or the data source 467 is used to receive a reference signal in the first reference signal resource sub-pool; at least one of the antenna 420, the transmitter 418, the transmitting processor 416, the multi-antenna transmitting processor 471, the controller/processor 475 or the memory 476 is used to transmit a reference signal in the first reference signal resource sub-pool.

In one embodiment, at least one of the antenna 452, the receiver 454, the receiving processor 456, the multi-antenna receiving processor 458, the controller/processor 459, the memory 460 or the data source 467 is used to determine the first function according to the receiving behavior in the first reference signal resource sub-pool.

In one embodiment, at least one of the antenna 420, the receiver 418, the receiving processor 470, the multi-antenna receiving processor 472, the controller/processor 475 or the memory 476 is used to receive the first information block; at least one of the antenna 452, the transmitter 454, the transmitting processor 468, the multi-antenna transmitting processor 457, the controller/processor 459, or the memory 460 is used to transmit the first information block.

In one embodiment, at least one of the antenna 452, the receiver 454, the receiving processor 456, the multi-antenna receiving processor 458, the controller/processor 459, the memory 460 or the data source 467 is used to receive the second information block; at least one of the antenna 420, the transmitter 418, the transmitting processor 416, the multi-antenna transmitting processor 471, the controller/processor 475 or the memory 476 is used to transmit the second information block.

In one embodiment, at least one of the antenna 420, the receiver 418, the receiving processor 470, the multi-antenna receiving processor 472, the controller/processor 475 or the memory 476 is used to receive the third information block; at least one of the antenna 452, the transmitter 454, the transmitting processor 468, the multi-antenna transmitting processor 457, the controller/processor 459, or the memory 460 is used to transmit the third information block.

In one embodiment, at least one of the antenna 452, the receiver 454, the receiving processor 456, the multi-antenna receiving processor 458, the controller/processor 459, the memory 460 or the data source 467 is used to determine the second function according to the receiving behavior in the first reference signal resource sub-pool.

In one embodiment, at least one of the antenna 420, the receiver 418, the receiving processor 470, the multi-antenna receiving processor 472, the controller/processor 475 or the memory 476 is used to receive the fourth information block; at least one of the antenna 452, the transmitter 454, the transmitting processor 468, the multi-antenna transmitting processor 457, the controller/processor 459, or the memory 460 is used to transmit the fourth information block.

In one embodiment, at least one of the antenna 420, the receiver 418, the receiving processor 470, the multi-antenna receiving processor 472, the controller/processor 475 or the memory 476 is used to receive the fifth information block; at least one of the antenna 452, the transmitter 454, the transmitting processor 468, the multi-antenna transmitting processor 457, the controller/processor 459, or the memory 460 is used to transmit the fifth information block.

### Embodiment 5

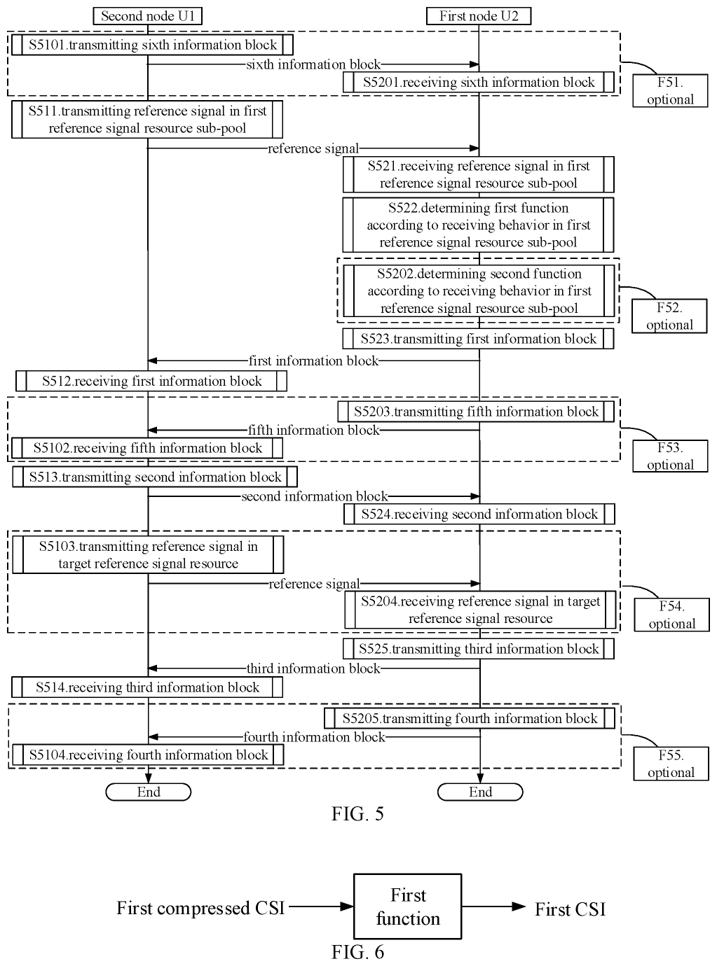

Embodiment 5 illustrates a flowchart of wireless transmission according to one embodiment of the present application, as shown in FIG. 5. In FIG. 5, a second node U1 and a first node U2 are communication nodes that transmit via an air interface. In FIG. 5, steps marked by boxes F51 to F55 are optional, respectively.

The second node U1 transmits a sixth information block in step S5101; and transmits a reference signal in a first reference signal resource sub-pool in step S511; receives a first information block in step S512; and receives a fifth information block in step S5102; transmits a second information block in step S513; and transmits a reference signal in a target reference signal resource in step S5103; receives a third information block in step S514; and receives a fourth information block in step S5104.

The first node U2 receives a sixth information block in step S5201; and receives a reference signal in a first reference signal resource sub-pool in step S521; determines a first function according to the receiving behavior in the first reference signal resource sub-pool in step S522; and determines a second function according to the receiving behavior in the first reference signal resource sub-pool in step S5202; and transmits a first information block in step S523; transmits a fifth information block in step S5203; and receives a second information block in step S524; and receives a reference signal in a target reference signal resource in step S5204; transmits a third information block in step S525; and transmits a fourth information block in step S5205.

In Embodiment 5, the first reference signal resource sub-pool comprises at least one reference signal resource; the first information block is used by the second node U1 to determine the first function; the second information block is used by the first node U2 to determine whether a target reference signal resource is associated with the first function; and the third information block indicates a first compressed CSI, the first compressed CSI being an input to the first function used by the second node U1 for generating a first CSI.

In one embodiment, the first node U2 is the first node in the present application.

In one embodiment, the second node U1 is the second node in the present application.

In one embodiment, an air interface between the second node U1 and the first node U2 includes a radio interface between a base station and a UE.

In one embodiment, an air interface between the second node U1 and the first node U2 includes a radio interface between a UE and another UE.

In one embodiment, the second node U1 is a maintenance base station for a serving cell of the first node U2.

In one embodiment, the first information block is transmitted in a PUSCH.

In one embodiment, the second information block is transmitted in a Physical Downlink Shared CHannel (PDSCH).

In one embodiment, the third information block is transmitted in a PUSCH.

In one embodiment, the third information block is transmitted in a PUCCH.

In one embodiment, the meaning of the phrase receiving a reference signal in a first reference signal resource sub-pool includes: receiving a reference signal in each reference signal resource in the first reference signal resource sub-pool.

In one embodiment, the meaning of the phrase receiving a reference signal in a first reference signal resource sub-pool includes: for any reference signal resource in the first reference signal resource sub-pool, receiving a reference signal transmitted according to configuration information of the any reference signal resource.

In one embodiment, the steps marked by the box F51 in FIG. 5 exist; the method in a first node for wireless communications comprises: receiving a sixth information block; herein, the sixth information block indicates a first reference signal resource pool, and any reference signal resource in the first reference signal resource sub-pool belongs to the first reference signal resource pool, the first reference signal resource pool comprising at least one reference signal resource; the first node determines the first function according to a reference signal received in reference signal resource(s) in the first reference signal resource pool.

In one embodiment, the first node determines the first function only according to a reference signal received in reference signal resource(s) in the first reference signal resource pool.

In one embodiment, the first node receives a reference signal only in the first reference signal resource sub-pool in the first reference signal resource pool.

In one embodiment, the sixth information block is carried by an RRC signaling.

In one embodiment, the sixth information block is carried by a MAC CE.

In one embodiment, the sixth information block is carried by a physical layer signaling.

In one embodiment, the sixth information block is carried by an RRC signaling and a MAC CE together.

In one embodiment, the sixth information block is carried by an IE.

In one embodiment, a name of an IE carrying the sixth information block includes “CSI-ReportConfig”.

In one embodiment, a name of an IE carrying the sixth information block includes “CSI-ResourceConfig”.

In one embodiment, the sixth information block and the second information block are carried by different fields in a same IE.

In one embodiment, the sixth information block and the second information block are carried by different IEs.

In one embodiment, the first reference signal resource sub-pool is the first reference signal resource pool.

In one embodiment, there is one reference signal resource in the first reference signal resource pool that does not belong to the first reference signal resource sub-pool.

In one embodiment, any reference signal resource in the first reference signal resource pool corresponds to a said first-type index; first-type indexes corresponding to any two reference signal resources in the first reference signal resource pool are of equal value.

In one embodiment, reference signal resources in the first reference signal resource pool belong to a same carrier.

In one embodiment, reference signal resources in the first reference signal resource pool belong to a same BWP.

In one embodiment, reference signal resources in the first reference signal resource pool belong to a same serving cell.

In one embodiment, there are two reference signal resources in the first reference signal resource pool that belong to different carriers.

In one embodiment, there are two reference signal resources in the first reference signal resource pool that belong to different BWPs.

In one embodiment, there are two reference signal resources in the first reference signal resource pool that belong to different serving cells.

In one embodiment, the steps marked by the box F51 in FIG. 5 do not exist.

In one embodiment, the step marked by the box F52 in FIG. 5 exists; the first node determines a second function according to the receiving behavior in the first reference signal resource sub-pool; an output of the second function comprises the first compressed CSI.

In one embodiment, the first node determines the second function only according to a reference signal received in reference signal resource(s) in the first reference signal resource pool.

In one embodiment, the steps marked by the box F53 in FIG. 5 exist; the fifth information block indicates whether the target reference signal resource is suitable to be associated with the first function.

In one embodiment, the fifth information block is transmitted in a PUSCH.

In one embodiment, the fifth information block is transmitted in a PUCCH.

In one embodiment, the fifth information block and the first information block are borne by a same signaling.

In one embodiment, the steps marked by the box F53 in FIG. 5 do not exist.

In one embodiment, the steps marked by the box F54 in FIG. 5 exist; the first node receives a reference signal in the target reference signal resource, and the second node transmits a reference signal in the target reference signal resource.

In one embodiment, the steps marked by the box F54 in FIG. 5 do not exist.

In one embodiment, the steps marked by the box F55 in FIG. 5 exist; the fourth information block indicates a second compressed CSI, the second compressed CSI being an input to a first enhancement function used by the second node U1 for generating a second CSI; herein, the first function is used for generating the first enhancement function; the second information block is used by the first node U2 to determine whether the target reference signal resource is associated with the first enhancement function.

In one embodiment, the first function is used by the first node U2 for generating the first enhancement function.

In one embodiment, the first function is used by the second node U1 for generating the first enhancement function.

In one embodiment, the fourth information block is borne by a physical layer signaling.

In one embodiment, the fourth information block comprises a CSI.

In one embodiment, the fourth information block is earlier than the third information block.

In one embodiment, the fourth information block is later than the third information block.

In one embodiment, the fourth information block is transmitted in a PUSCH.

In one embodiment, the fourth information block is transmitted in a PUCCH.

### Embodiment 6

Embodiment 6 illustrates a schematic diagram of a relation between a first CSI and a first compressed CSI according to one embodiment of the present application; as shown in FIG. 6. In Embodiment 6, the first compressed CSI is an input to the first function used for generating the first CSI.

In one embodiment, the first compressed CSI comprises a Precoding Matrix Indicator (PMI).

In one embodiment, the first compressed CSI comprises one or more of a Channel Quality Indicator (CQI), a CSI-RS Resource Indicator (CRI) or a Rank Indicator (RI).

In one embodiment, the first compressed CSI comprises a matrix.

In one embodiment, the first compressed CSI comprises a vector.

In one embodiment, the first compressed CSI comprises information of a channel matrix.

In one embodiment, the first compressed CSI comprises information of amplitudes and phases of elements in a channel matrix.

In one embodiment, the first CSI is an output of the first function with the input being the first compressed CSI.

In one embodiment, the first CSI comprises a PMI.

In one embodiment, the first CSI comprises one or more of a CQI, a CRI or a RI.

In one embodiment, the first CSI comprises a channel matrix.

In one embodiment, the first CSI comprises information of amplitudes and phases of elements in a channel matrix.

In one embodiment, the first CSI comprises information of a channel matrix.

In one embodiment, the first CSI comprises a first matrix, while the first compressed CSI comprises a second matrix, where a number of elements in the second matrix is less than a number of elements in the first matrix.

In one subembodiment, a product of a number of rows and a number of columns of the second matrix is smaller than a product of a number of rows and a number of columns of the first matrix.

In one subembodiment, the second matrix is a vector.

In one embodiment, the first CSI consists of Q1 bits, while the first compressed CSI consists of Q2 bits, Q1 and Q2 being positive integers greater than 1 respectively, Q1 being greater than Q2.

### Embodiment 7

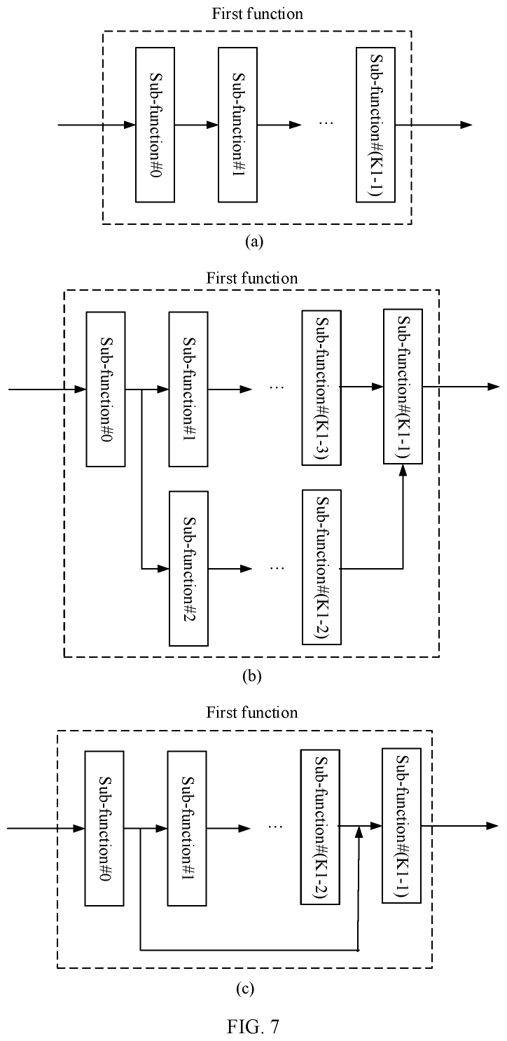

Embodiment 7 illustrates a schematic diagram of a first function according to one embodiment of the present application; as shown in FIG. 7. In Embodiment 7, the first function comprises K1 sub-functions, K1 being a positive integer greater than 1. In FIG. 7, the K1 sub-functions are respectively expressed in sub-function #0 . . . , and sub-function #(K1-1).

In one embodiment, the first node determines the first function according to the receiving behavior in all reference signal resources in the first reference signal resource sub-pool.

In one embodiment, the first node determines the first function according to the receiving behavior in only part of reference signal resources in the first reference signal resource sub-pool.

In one embodiment, the meaning of the phrase of determining a first function according to the receiving behavior in the first reference signal resource sub-pool includes: a measurement of a reference signal received in the first reference signal resource sub-pool is used for determining the first function.

In one embodiment, the meaning of the phrase of determining a first function according to the receiving behavior in the first reference signal resource sub-pool includes: the first node obtains a channel measurement for determining the first function based on a reference signal received in the first reference signal resource sub-pool.

In one embodiment, the meaning of the phrase of determining a first function according to the receiving behavior in the first reference signal resource sub-pool includes: the first node obtains a channel measurement for determining the first function only based on a reference signal received in the first reference signal resource sub-pool.

In one embodiment, the meaning of the phrase of determining a first function according to the receiving behavior in the first reference signal resource sub-pool includes: a channel estimation value obtained by a measurement of a reference signal received in the first reference signal resource sub-pool through channel estimation is used for determining the first function.

In one embodiment, the first function is non-linear.

In one embodiment, an input to the first function includes a compressed CSI, and an output of the first function includes a resumed CSI not yet compressed.

In one embodiment, a payload of any input to the first function is smaller than a payload of an output of the first function corresponding to the input.

In one embodiment, a number of elements comprised by any input to the first function is smaller than a number of elements comprised by an output of the first function corresponding to the input.

In one embodiment, the first function comprises a Neural Network.

In one embodiment, the first function comprises a Neural Network for CSI compression.

In one embodiment, the first function comprises a decoder of a Neural Network for CSI compression.

In one embodiment, the first function comprises a first parameter group, the first parameter group comprising at least one parameter.

In one embodiment, the K1 sub-functions include one or more types of convolution function, pooling function, concatenated function or activation function.

In one embodiment, the first parameter group comprises one or more of a convolutional kernel, pooling function, pooling function parameters, activation function, a threshold of activation function, or weights between feature maps.

In one embodiment, the first parameter group comprises K1 parameter sub-groups, the K1 parameter sub-groups being respectively used for the K1 sub-functions.

In one embodiment, there is one sub-function among the K1 sub-functions that comprises a pre-processing layer.

In one subembodiment, the sub-function #0 in FIG. 7 comprises a pre-processing layer.

In one subembodiment, the pre-processing layer is a fully connected layer.

In one subembodiment, the pre-processing layer enlarges the size of an input to the first function.

In one embodiment, there is one sub-function among the K1 sub-functions that comprises a pooling layer.

In one embodiment, there is one sub-function among the K1 sub-functions that comprises at least one convolution layer.

In one embodiment, there is one sub-function among the K1 sub-functions that comprises at least one decoding layer.

In one embodiment, there are two sub-functions among the K1 sub-functions that respectively comprise a fully connected layer and at least one decoding layer.

In one embodiment, P1 sub-functions are a subset of the K1 sub-functions, P1 being a positive integer greater than 1 and less than K1; any sub-function among the P1 sub-functions comprises at least one decoding layer.

In one subembodiment, any two sub-functions among the P1 sub-functions have identical characteristics; the characteristics include a number of decoding layers, a size of an input parameter and a size of an output parameter per decoding layer.

In one embodiment, the decoding layer comprises at least one convolution layer.

In one embodiment, the decoding layer comprises at least one convolution layer and a pooling layer.

In one embodiment, the first parameter group comprises at least one of a convolutional kernel comprised by any decoding layer in the P1 sub-functions or weights between different decoding layers in the P1 sub-functions.

In one embodiment, the meaning of the phrase of determining a first function includes: determining values of parameters in the first parameter group.

In one embodiment, the meaning of the phrase of determining a first function includes: determining all or part of characteristics of the first function.

In one embodiment, the second node indicates to the first node at least part of characteristics of the first function.

In one embodiment, the characteristics of the first function include: one or more of a convolutional kernel size, a number of convolution layers, a convolution step, a pooling kernel size, a step of pooling kernel, pooling function, activation function or a number of feature maps.

In one embodiment, the characteristics of the first function include: the value of K1 and relations among the K1 sub-functions.

In one subembodiment, the relations among the K1 sub-functions include at least one of which sub-functions are cascaded, which sub-functions are parallel, or a sequential order of the K1 sub-functions.

In one embodiment, the characteristics of the first function include: the value of P1 and the characteristics of any one of the P1 sub-functions.

In one embodiment, the sixth information block indicates the at least part of characteristics of the first function.

In one embodiment, the second information block indicates the at least part of characteristics of the first function.

In one embodiment, under the circumstances where the at least part of characteristics of the first function are indicated, the first node determines the first function according to the receiving behavior in the first reference signal resource sub-pool.

In one embodiment, the meaning of the phrase of determining a first function includes: determining other characteristics of the first function other than the characteristics indicated by the first node.

In one embodiment, the first information block indicates at least one of the other characteristics of the first function or the first parameter group.

In one embodiment, there are two sub-functions being concatenated among the K1 sub-functions, namely, an input to one of the two sub-functions is an output of the other one of the two sub-functions.

In one subembodiment, the sub-function #0 and the sub-function #1 in FIGS. 7(a) and (c) are cascaded.

In one embodiment, there are two sub-functions being parallel among the K1 sub-functions; namely, outputs of the two sub-functions are used together as an input to a third sub-function among the K1 sub-functions, or, an output of a third sub-function among the K1 sub-functions is used as an input to both of the two sub-functions.

In one subembodiment, the sub-function #1 and the sub-function #2 in FIG. 7(b) are parallel.

In one subembodiment, the sub-function #(K1-3) and the sub-function #(K1-2) in FIG. 7(b) are parallel.

### Embodiment 8

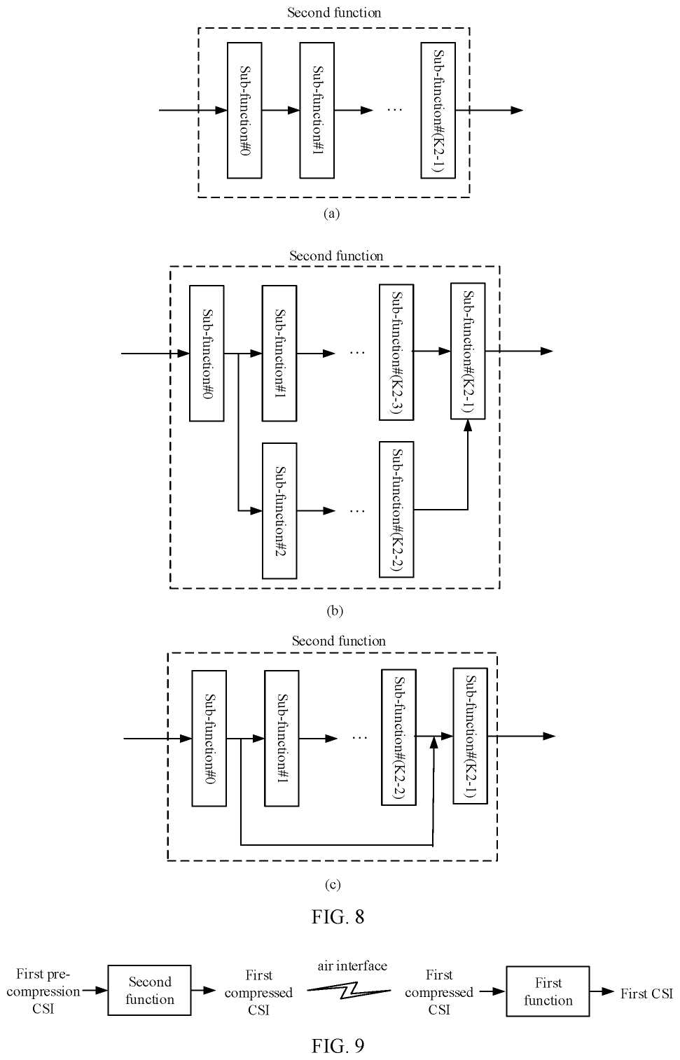

Embodiment 8 illustrates a schematic diagram of a second function according to one embodiment of the present application; as shown in FIG. 8. In Embodiment 8, the second function comprises K2 sub-functions, K2 being a positive integer greater than 1. In FIG. 8, the K2 sub-functions are respectively expressed in sub-function #0 . . . , and sub-function #(K2-1).

In one embodiment, the second function is used by the first node for generating the first compressed CSI.

In one embodiment, the second function is non-linear.

In one embodiment, an input to the second function comprises a result of a channel measurement.

In one embodiment, an output of the second function comprises a compressed CSI.

In one embodiment, a number of elements comprised by any input to the second function is larger than a number of elements comprised by an output of the second function corresponding to the input.

In one embodiment, a payload of any input to the second function is larger than a payload of an output of the second function corresponding to the input.

In one embodiment, the second function comprises a Neural Network.

In one embodiment, the second function comprises a Neural Network for CSI compression.

In one embodiment, the second function comprises an encoder of a Neural Network for CSI compression.

In one embodiment, the K2 sub-functions include one or more types of convolution function, pooling function, concatenated function or activation function.

In one embodiment, the second function comprises a second parameter group, the second parameter group comprising at least one parameter.

In one embodiment, the second parameter group comprises one or more of a convolutional kernel, pooling function, pooling function parameters, activation function, a threshold of activation function, or weights between feature maps.

In one embodiment, the second parameter group comprises K2 parameter sub-groups, the K2 parameter sub-groups being respectively used for the K2 sub-functions.

In one embodiment, there is one sub-function among the K2 sub-functions that comprises a fully connected layer.

In one subembodiment, the sub-function #(K2-1) in FIG. 8 comprises a fully connected layer.

In one embodiment, there is one sub-function among the K2 sub-functions that comprises a pooling layer.

In one embodiment, there is one sub-function among the K2 sub-functions that comprises at least one convolution layer.

In one embodiment, there is one sub-function among the K2 sub-functions that comprises at least one convolution layer and a pooling layer.

In one embodiment, there is one sub-function among the K2 sub-functions that comprises at least one encoder layer.

In one embodiment, there are two sub-functions among the K2 sub-functions that respectively comprise a fully connected layer and at least one encoder layer.

In one embodiment, an encoder layer comprises at least one convolution layer and a pooling layer.

In one embodiment, at the convolution layer, at least one convolutional kernel is used for convoluting an input to the second function for generating corresponding feature map(s), and at least one feature map output by the convolution layer is/are reshaped as a vector to be input to a fully connected layer; and the fully connected layer converts the vector into an output of the second function.

In one embodiment, the second parameter group comprises at least one of a number of sub-functions comprising convolution layers among the K2 sub-functions, a convolutional kernel of any convolution layer in the K2 sub-functions, or weights between different convolution layers in the K2 sub-functions.

In one embodiment, the meaning of the phrase of determining a second function includes: determining values of parameters in the second parameter group.

In one embodiment, there are two sub-functions being concatenated among the K2 sub-functions, namely, an input to one of the two sub-functions is an output of the other one of the two sub-functions.

In one subembodiment, the sub-function #0 and the sub-function #1 in FIGS. 8(a) and (b) are cascaded.

In one embodiment, there are two sub-functions being parallel among the K2 sub-functions; namely, outputs of the two sub-functions are used together as an input to a third sub-function among the K2 sub-functions, or, an output of a third sub-function among the K2 sub-functions is used as an input to both of the two sub-functions.

In one subembodiment, the sub-function #1 and the sub-function #2 in FIG. 8(b) are parallel.

In one subembodiment, the sub-function #(K2-3) and the sub-function #(K2-2) in FIG. 8(b) are parallel.

In one embodiment, the second node indicates to the first node at least part of characteristics of the second function.

In one embodiment, the characteristics of the second function include: one or more of a convolutional kernel size, a number of convolution layers, a convolution step, a pooling kernel size, a step of pooling kernel, pooling function, activation function or a number of feature maps.

In one embodiment, the characteristics of the second function include: at least one of the value of K2, a number of sub-functions comprising convolution layers among the K2 sub-functions, a size of an input parameter and a size of an output parameter per convolution layer, or relations among the K2 sub-functions.

In one subembodiment, the relations among the K2 sub-functions include at least one of which sub-functions are cascaded, which sub-functions are parallel, or a sequential order of the K2 sub-functions.

In one embodiment, the sixth information block indicates the at least part of characteristics of the second function.

### Embodiment 9

Embodiment 9 illustrates a schematic diagram of relations among a first CSI, a first compressed CSI, a first function and a second function according to one embodiment of the present application; as shown in FIG. 9. In Embodiment 9, a first pre-compression CSI is an input to the second function used by the first node for generating the first compressed CSI; the first compressed CSI is an input to the first function used by the second node for generating the first CSI.

In one embodiment, the first CSI comprises an estimated value of the first pre-compression CSI.

In one embodiment, the first compressed CSI is an output of the second function with the input being the first pre-compression CSI.

In one embodiment, the first compressed CSI is borne by the third information block, the third information block being transmitted by the first node, and being received by the second node via an air interface.

In one embodiment, the second function is used for compressing the first pre-compression CSI to reduce the radio overhead of the first compressed CSI, and the first function is used for decompressing the first compressed CSI to resume the first pre-compression CSI as much as possible.

In one embodiment, the first node obtains a channel measurement for generating the first pre-compression CSI based on a reference signal received in a first reference signal resource.

In one embodiment, the first reference signal resource comprises a CSI-RS resource or a SS/PBCH Block resource.

In one embodiment, the first reference signal resource comprises a DMRS port.

In one embodiment, the second information block indicates that the target reference signal resource is associated with the first function, the first reference signal resource being the target reference signal resource.

In one embodiment, the first reference signal resource and the target reference signal resource correspond to different reference signal resource identities.

In one embodiment, the first reference signal resource belongs to the first reference signal resource sub-pool.

In one embodiment, the first reference signal resource does not belong to the first reference signal resource sub-pool.

In one embodiment, the first node obtains a first channel matrix based on a reference signal received in the first reference signal resource, where any element in the first channel matrix represents a channel over which a radio signal transmitted on one RS port of the first reference signal resource is conveyed on a frequency unit; the first channel matrix is used for generating the first pre-compression CSI.

In one subembodiment, the first CSI comprises information of amplitudes and phases of elements in the first channel matrix.

In one subembodiment, the first CSI comprises an estimated value of the first channel matrix.

In one subembodiment, the first pre-compression CSI comprises information of amplitudes and phases of elements in the first channel matrix.

In one subembodiment, the first pre-compression CSI comprises the first channel matrix.

In one subembodiment, the first pre-compression CSI is obtained by the first channel matrix through mathematical transformation.

In one embodiment, the frequency unit is a subcarrier.

In one embodiment, the frequency unit is a Physical Resource Block (PRB).

In one embodiment, the frequency unit is comprised of multiple consecutive subcarriers.

In one embodiment, the frequency unit is comprised of multiple consecutive PRBs.

In one embodiment, the mathematical transformation includes Discrete Fourier Transform (DFT).

In one embodiment, the mathematical transformation includes one or more of quantization, transform from spatial domain to angle domain, transform from frequency domain to time domain, or truncation.

In one embodiment, optimization objectives of the first node when determining the first function include: optimizing an error between the first CSI and the first pre-compression CSI.

In one embodiment, the optimizing includes: to minimize.

In one embodiment, the optimizing includes: to make the value no greater than a given threshold.

In one embodiment, the error includes at least one of a Mean Square Error (MSE), a Linear Minimum MSE (LMNISE) or a Normalized MSE (NMSE).

In one embodiment, the first function is a reverse function of the second function.

In one embodiment, the second function is established at the first node, while the first function is established at both the first node and the second node.

In one embodiment, an encoder and a decoder based on CsiNet or CRNet are respectively used for implementing the second function and the first function.

In one subembodiment, for a detailed description of CsiNet, refer to Chao-Kai Wen, Deep Learning for Massive CSI Feedback, 2018 IEEE Wireless Communications Letters, vol. 7 No. 5, October 2018, etc.

In one subembodiment, for a detailed description of CRNet, refer to Zhilin Lu, Multi-resolution CSI Feedback with Deep Learning in Massive MIMO System, 2020 IEEE International Conference on Communications (ICC), etc.

In one embodiment, the first node determines the first function and the second function together according to the receiving behavior in the first reference signal resource sub-pool.

In one embodiment, the meaning of the phrase that the target reference signal resource is associated with the first function includes: a measurement of a reference signal received in the target reference signal resource is used as an input to the second function.

In one embodiment, the meaning of the phrase that the target reference signal resource is associated with the first function includes: a measurement of a reference signal received in the target reference signal resource is used for generating an input to the second function.

In one embodiment, the meaning of the phrase that the target reference signal resource is associated with the first function includes: the first node will obtain a channel measurement for calculating an input to the second function based on a reference signal received in the target reference signal resource.

In one embodiment, the meaning of the phrase that the target reference signal resource is associated with the first function includes: the second function is used for compressing a CSI obtained based on a channel measurement of a reference signal received in the target reference signal resource.

### Embodiment 10

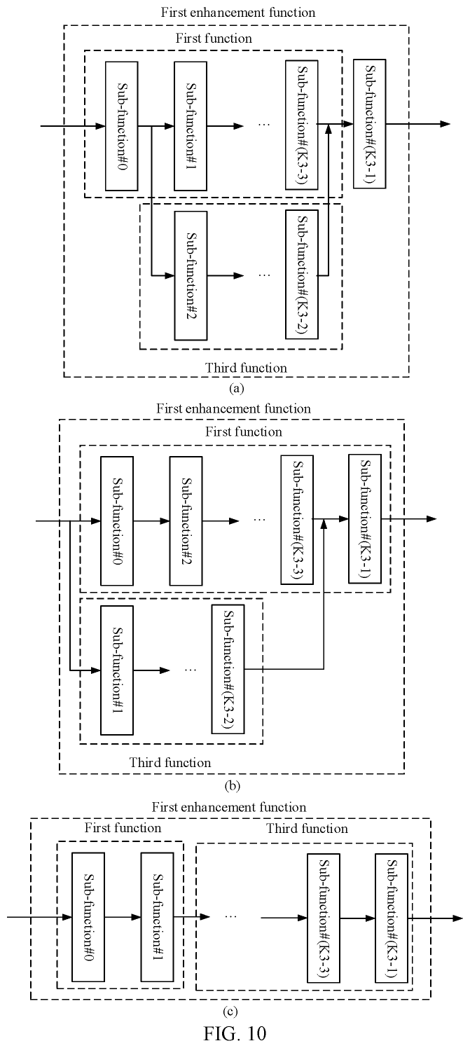

Embodiment 10 illustrates a schematic diagram of a first enhancement function according to one embodiment of the present application; as shown in FIG. 10. In Embodiment 10, the first function and the third function are used for generating the first enhancement function.

In one embodiment, the first enhancement function is non-linear.

In one embodiment, an input to the first enhancement function includes a compressed CSI, and an output of the first enhancement function includes a resumed pre-compression CSI.

In one embodiment, a payload of any input to the first enhancement function is smaller than a payload of an output of the first enhancement function corresponding to the input.

In one embodiment, a number of elements comprised by any input to the first enhancement function is smaller than a number of elements comprised by an output of the first enhancement function corresponding to the input.

In one embodiment, the first enhancement function comprises a Neural Network.

In one embodiment, the first enhancement function comprises a Neural Network for CSI compression.

In one embodiment, the first enhancement function comprises a decoder of a Neural Network for CSI compression.

In one embodiment, the first enhancement function comprises the first function.

In one embodiment, the first enhancement function comprises K3 sub-functions, K3 being a positive integer greater than 1; the K3 sub-functions include one or more types of convolution function, pooling function, concatenated function or activation function. In FIG. 10, the K3 sub-functions are respectively expressed in sub-function #0 . . . , and sub-function #(K3-1).

In one embodiment, the first function and the third function are respectively comprised of partial sub-functions among the K3 sub-functions.

In one embodiment, the K1 sub-functions are a subset of the K3 sub-functions.

In one embodiment, at least one of the K3 sub-functions comprises at least one convolution layer.

In one embodiment, a number of convolution layers comprised by the first enhancement function is greater than a number of convolution layers comprised by the first function.

In one embodiment, an input to the first function is an input to the first enhancement function.

In one embodiment, the third function includes one or more of convolutional, pooling, concatenated or activation functions.

In one embodiment, the first enhancement function is formed by concatenating the first function and the third function.

In one embodiment, an output of the first function is an input to the third function, and an output of the third function is an output of the first enhancement function, as shown in FIG. 10(c).

In one embodiment, the first function and the third function are connected in parallel for generating the first enhancement function.

In one embodiment, the first function and the third function share a same input, as shown in FIG. 10(b).

In one embodiment, one of the K1 sub-functions and the third function share a same input; for instance, in FIG. 10(a), the sub-function #1 in the first function shares a same input with the third function.

In one embodiment, an output of one of the K1 sub-functions is an input to the third function; for instance, in FIG. 10(a), an output of the sub-function #0 in the first function is an input to the third function.

In one embodiment, an output of one of the K1 sub-functions and an output of the third function are used together as an input to another one of the K1 sub-functions; for instance, an output of the sub-function #(K3-3) in the first function and an output of the third function are used together as an input to the sub-function #(K3-1) in the first function.

In one embodiment, an output of the first function is an output of the first enhancement function; as shown in FIG. 10(b).

In one embodiment, an output of the first function and an output of the third function are used together as an input to a fourth function, and an output of the fourth function is an output of the first enhancement function; for instance, as shown in FIG. 10(a), the fourth function comprises the sub-function #(K3-1) in FIG. 10(a).

In one embodiment, the first node determines the first enhancement function according to the receiving behavior in the first reference signal resource sub-pool.

In one embodiment, the meaning of the phrase that the target reference signal resource is associated with the first enhancement function is similar to that of the phrase that the target reference signal resource is associated with the first function, except that the first function is substituted with the first enhancement function.

In one embodiment, the phrase determining the first enhancement function according to the receiving behavior in the first reference signal resource sub-pool has similar meaning to the phrase determining a first function according to the receiving behavior in the first reference signal resource sub-pool, except that the first function is substituted with the first enhancement function.

In one embodiment, the first node determines the first enhancement function according to the receiving behavior in all reference signal resources in the first reference signal resource sub-pool.

In one embodiment, the first node determines the first enhancement function according to the receiving behavior in only part of reference signal resources in the first reference signal resource sub-pool.

In one embodiment, the first node determines the first function according to the receiving behavior in part of reference signal resources in the first reference signal resource sub-pool, and determines the first enhancement function according to the receiving behavior in the other part of reference signal resources in the first reference signal resource sub-pool.

In one subembodiment, the part of reference signal resources and the other part of reference signal resources do not comprise any common reference signal resource.

In one embodiment, the second information block indicates that the target reference signal resource is associated with the first function, but is not associated with the first enhancement function.

In one embodiment, the second information block indicates that the target reference signal resource is associated with the first function, and is also associated with the first enhancement function.

In one embodiment, the second information block indicates that the target reference signal resource is associated with the first enhancement function, but is not associated with the first function.

In one embodiment, the second information block indicates that the target reference signal resource is associated with neither the first function nor the first enhancement function.

In one embodiment, if the target reference signal resource is associated with the first enhancement function, the target reference signal resource is associated with the first function.

In one embodiment, a measurement of the target reference signal resource is used for generating a target compressed CSI; if the target reference signal resource is associated not only with the first function but also with the first enhancement function, the target compressed CSI is used as an input to the first enhancement function for generating a target CSI; if the target reference signal resource is not associated with the first enhancement function but with the first function, the target compressed CSI is used as an input to the first function for generating a target CSI.

### Embodiment 11

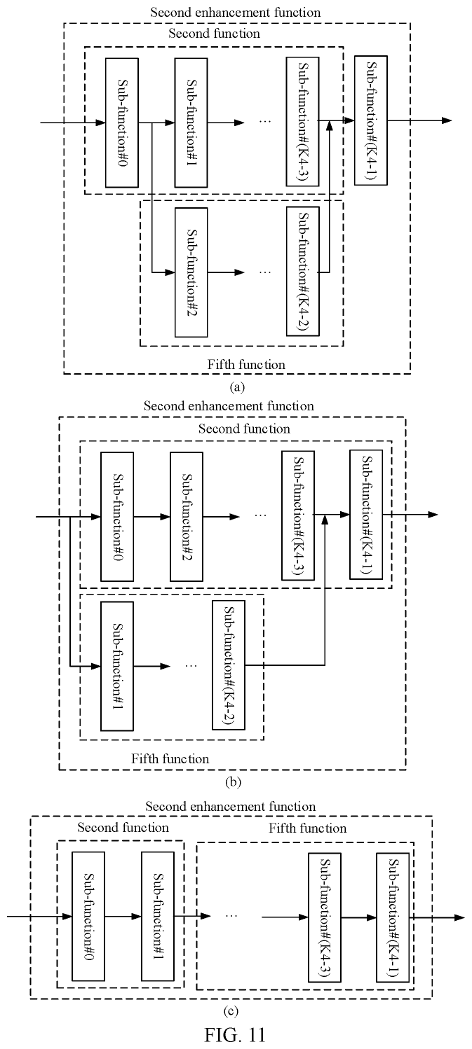

Embodiment 11 illustrates a schematic diagram of a second enhancement function according to one embodiment of the present application; as shown in FIG. 11. In Embodiment 11, the second function and a fifth function are used for generating a second enhancement function, an output of the second enhancement function comprising the second compressed CSI.

In one embodiment, the second enhancement function is used by the first node for generating the second compressed CSI.

In one embodiment, the second enhancement function is non-linear.

In one embodiment, an input to the second enhancement function comprises a result of a channel measurement.

In one embodiment, an input to the second enhancement function comprises a channel matrix.

In one embodiment, an output of the second enhancement function comprises a compressed CSI.

In one embodiment, a payload of any input to the second enhancement function is larger than a payload of an output of the second enhancement function corresponding to the input.

In one embodiment, a number of elements comprised by any input to the second enhancement function is larger than a number of elements comprised by an output of the second enhancement function corresponding to the input.

In one embodiment, the second enhancement function comprises a Neural Network.

In one embodiment, the second enhancement function comprises a Neural Network for CSI compression.

In one embodiment, the second enhancement function comprises an encoder of a Neural Network for CSI compression.

In one embodiment, the second enhancement function comprises the second function.

In one embodiment, the second enhancement function comprises K4 sub-functions, K4 being a positive integer greater than 1; the K4 sub-functions include one or more types of convolution function, pooling function, concatenated function or activation function. In FIG. 11, the K4 sub-functions are respectively expressed in sub-function #0 . . . , and sub-function #(K4-1).

In one embodiment, the second function and the fifth function are respectively comprised of partial sub-functions among the K4 sub-functions.

In one embodiment, the K2 sub-functions are a subset of the K4 sub-functions.

In one embodiment, at least one of the K4 sub-functions comprises at least one convolution layer.

In one embodiment, a number of convolution layers comprised by the second enhancement function is greater than a number of convolution layers comprised by the second function.

In one embodiment, an input to the second function is an input to the second enhancement function.

In one embodiment, the fifth function includes one or more of convolutional, pooling, concatenated or activation functions.

In one embodiment, the second enhancement function is formed by concatenating the second function and the fifth function.

In one embodiment, an output of the second function is an input to the fifth function, and an output of the fifth function is an output of the second enhancement function; as shown in FIG. 11(c).

In one embodiment, the second function and the fifth function are connected in parallel for generating the second enhancement function.

In one embodiment, the second function and the fifth function share a same input; as shown in FIG. 11(b).

In one embodiment, one of the K2 sub-functions and the fifth function share a same input; for instance, the sub-function #1 in the second function in FIG. 11(a) and the fifth function share a same input.

In one embodiment, an output of one of the K2 sub-functions is an input to the fifth function; for instance, an output of the sub-function #0 in the second function in FIG. 11(a) is an input to the fifth function.

In one embodiment, an output of one of the K2 sub-functions and an output of the fifth function are used together as an input to another one of the K2 sub-functions; for instance, an output of the sub-function #(K4-3) in the second function in FIG. 11(b) and an output of the fifth function are used together as an input to the sub-function #(K4-1) in the second function.

In one embodiment, an output of the second function is an output of the second enhancement function.

In one embodiment, an output of the second function and an output of the fifth function are used together as an input to a sixth function, and an output of the sixth function is an output of the second enhancement function; for instance, as shown in FIG. 11(a), the sixth function comprises the sub-function #(K4-1) in FIG. 11(a).

In one embodiment, the meaning of the phrase that the target reference signal resource is associated with the first enhancement function is similar to that of the phrase that the target reference signal resource is associated with the first function, except that the first function is substituted with the first enhancement function and that the second function is substituted with the second enhancement function.

In one embodiment, the first node determines the second enhancement function according to the receiving behavior in the first reference signal resource sub-pool.

In one embodiment, the first node determines the second function according to the receiving behavior in part of reference signal resources in the first reference signal resource sub-pool, and determines the second enhancement function according to the receiving behavior in the other part of reference signal resources in the first reference signal resource sub-pool.

In one subembodiment, the part of reference signal resources and the other part of reference signal resources do not comprise any common reference signal resource.

### Embodiment 12

Embodiment 12 illustrates a schematic diagram of relations among a second CSI, a second compressed CSI, a first enhancement function and a second enhancement function according to one embodiment of the present application; as shown in FIG. 12. In Embodiment 12, a second pre-compression CSI is an input to the second enhancement function used by the first node for generating the second compressed CSI, and the second compressed CSI is an input to the first enhancement function used by the second node for generating the second CSI.

In one embodiment, the second CSI comprises an estimated value of the second pre-compression CSI.

In one embodiment, the second compressed CSI is borne by the fourth information block, the fourth information block being transmitted by the first node, and being received by the second node via an air interface.

In one embodiment, the first node obtains a channel measurement for generating the second compressed CSI based on a reference signal received in the first reference signal resource sub-pool.

In one embodiment, the second compressed CSI is unrelated to a measurement of a reference signal received in the first reference signal resource sub-pool.

In one embodiment, the second information block indicates that the target reference signal resource is associated with the first enhancement function, and the first node obtains a channel measurement for generating the second compressed CSI based on a reference signal received in the target reference signal resource.

In one embodiment, the second compressed CSI is unrelated to a measurement of a reference signal received in the target reference signal resource.

In one embodiment, the second information block indicates that the target reference signal resource is not associated with the first enhancement function, and the second compressed CSI is unrelated to a measurement of a reference signal received in the target reference signal resource.

In one embodiment, the second CSI comprises a PMI.

In one embodiment, the second CSI comprises one or more of a CQI, a CRI or a RI.

In one embodiment, the second CSI comprises a channel matrix.

In one embodiment, the second CSI comprises information of amplitudes and phases of elements in a channel matrix.

In one embodiment, the second compressed CSI comprises a PMI.

In one embodiment, the second compressed CSI comprises one or more of a CQI, a CRI or a RI.

In one embodiment, the second compressed CSI comprises information of amplitudes and phases of elements in a channel matrix.

In one embodiment, the second compressed CSI comprises a matrix.

In one embodiment, the second compressed CSI comprises a vector.

In one embodiment, the second CSI comprises a third matric, while the second compressed CSI comprises a fourth matrix, where a number of elements in the fourth matrix is less than a number of elements in the third matrix.

In one subembodiment, the fourth matrix is a vector.

In one subembodiment, a product of a number of rows and a number of columns of the fourth matrix is smaller than a product of a number of rows and a number of columns of the third matrix.

In one embodiment, the second CSI consists of Q3 bits, while the second compressed CSI consists of Q4 bits, Q3 and Q4 being positive integers greater than 1 respectively, Q3 being greater than Q4.

In one embodiment, the first enhancement function is a reverse function of the second enhancement function.

In one embodiment, the first node obtains a channel measurement for calculating the second pre-compression CSI based on a reference signal received in a second reference signal resource.

In one embodiment, the second reference signal resource comprises a CSI-RS resource or a SS/PBCH Block resource.

In one embodiment, the second reference signal resource comprises a DMRS port.

In one embodiment, the second information block indicates that the target reference signal resource is associated with the first enhancement function, the second reference signal resource being the target reference signal resource.

In one embodiment, the second reference signal resource and the target reference signal resource correspond to different reference signal resource identities.

In one embodiment, the second reference signal resource belongs to the first reference signal resource sub-pool.

In one embodiment, the second reference signal resource does not belong to the first reference signal resource sub-pool.

In one embodiment, the second reference signal resource and the first reference signal resource correspond to different reference signal resource identities.

In one embodiment, the first node obtains a second channel matrix based on a channel measurement of a reference signal received in the second reference signal resource, where any element in the second channel matrix represents a channel over which a radio signal transmitted on one RS port of the second reference signal resource is conveyed on a frequency unit; the second channel matrix is used for generating the second pre-compression CSI.

In one subembodiment, the second CSI comprises information of amplitudes and phases of elements in the second channel matrix.

In one subembodiment, the second CSI comprises an estimated value of the second channel matrix.

In one subembodiment, the second pre-compression CSI comprises the second channel matrix.

In one subembodiment, the second pre-compression CSI comprises information of amplitudes and phases of elements in the second channel matrix.

In one subembodiment, the second pre-compression CSI is obtained by the second channel matrix through mathematical transformation.

### Embodiment 13

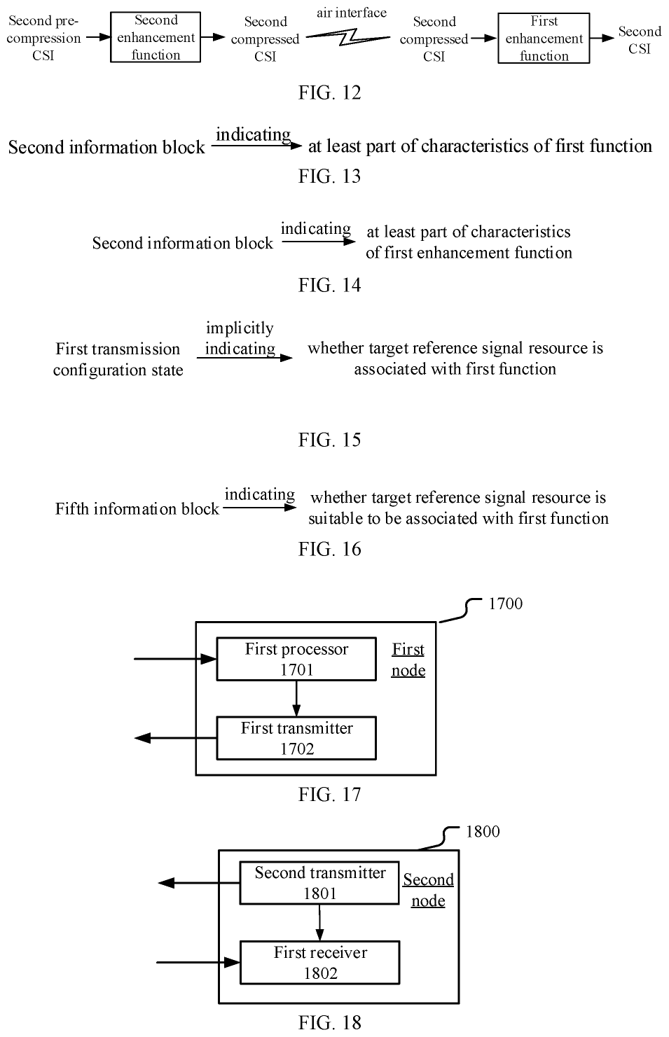

Embodiment 13 illustrates a schematic diagram of a second information block indicating at least part of characteristics of a first function according to one embodiment of the present application; as shown in FIG. 13.

In one embodiment, the second information block comprises a second bit field, with a value of the second bit field indicating the at least part of characteristics of the first function.

In one embodiment, the second information block indicates the at least part of characteristics of the second function.

### Embodiment 14

Embodiment 14 illustrates a schematic diagram of a second information block indicating at least part of characteristics of a first enhancement function according to one embodiment of the present application; as shown in FIG. 14.

In one embodiment, the second information block comprises a third bit field, with a value of the third bit field indicating at least part of characteristics of the first enhancement function.

In one embodiment, the characteristics of the first enhancement function include: one or more of a relation between the first function and the third function, the characteristics of the first function or characteristics of the third function.

In one subembodiment, the characteristics of the third function include: one or more of a convolutional kernel size, a number of convolution layers, a convolution step, a pooling kernel size, a step of pooling kernel, pooling function, activation function or a number of feature maps.

In one subembodiment, the characteristics of the third function include: at least one of the value of K3, which of the K3 sub-functions are cascaded, which of the K3 sub-functions are parallel, or a sequential order of the K3 sub-functions.

In one embodiment, the second information block indicates at least part of characteristics of the second enhancement function.

In one embodiment, the characteristics of the second enhancement function include: one or more of a relation between the second function and the fifth function, the characteristics of the second function or characteristics of the fifth function.

In one subembodiment, the characteristics of the fifth function include: one or more of a convolutional kernel size, a number of convolution layers, a convolution step, a pooling kernel size, a step of pooling kernel, pooling function, activation function or a number of feature maps.

In one subembodiment, the characteristics of the fifth function include: at least one of the value of K4, which of the K4 sub-functions are cascaded, which of the K4 sub-functions are parallel, or a sequential order of the K4 sub-functions.

### Embodiment 15

Embodiment 15 illustrates a schematic diagram of a first transmission configuration state implicitly indicating whether a target reference signal resource is associated with a first function according to one embodiment of the present application; as shown in FIG. 15.

In one embodiment, the second information block indicates the first transmission configuration state.

In one embodiment, the first transmission configuration state includes a Transmission Configuration Indicator (TCI) state.

In one embodiment, the first transmission configuration state is a TCI state.

In one embodiment, the first transmission configuration state indicates a QCL relation.

In one embodiment, the first transmission configuration state comprises a parameter used for configuring a QCL relation between an RS port of the target reference signal resource and one or two reference signals.

In one embodiment, the first transmission configuration state is a TCI state, and the second information block indicates a TCI-StateId corresponding to the first transmission configuration state.

In one embodiment, the first transmission configuration state is a TCI state of the target reference signal resource.

In one embodiment, the second information block indicates that a TCI state of the target reference signal resource is the first transmission configuration state.

In one embodiment, the first transmission configuration state is used to determine a QCL relation of the target reference signal resource.

In one embodiment, the first transmission configuration state is used to determine a Spatial Rx parameter of the target reference signal resource.

In one embodiment, the first transmission configuration state is used to determine large-scale properties of a channel over which a reference signal received in the target reference signal resource is conveyed.

In one embodiment, the large-scale properties include one or more of a delay spread, a Doppler spread, a Doppler shift, an average delay or a Spatial Rx parameter.

In one embodiment, the first transmission configuration state indicates a third reference signal resource.

In one subembodiment, the third reference signal resource comprises a CSI-RS resource or a SS/PBCH resource.

In one subembodiment, an RS port of the target reference signal resource and an RS port of the third reference signal resource are QCL.

In one subembodiment, the first transmission configuration state indicates that a QCL type corresponding to the third reference signal resource is QCL-TypeD, and an RS port of the target reference signal resource and an RS port of the third reference signal resource are QCL with QCL-TypeD.

In one subembodiment, the first node can infer large-scale properties of a channel over which a reference signal in the target reference signal resource is conveyed from large-scale properties of a channel over which a reference signal in the third reference signal resource is conveyed.

In one subembodiment, the first node can infer a spatial Rx parameter of a reference signal in the target reference signal resource from a spatial Rx parameter of a reference signal in the third reference signal resource.

In one embodiment, if the first transmission configuration state belongs to a first transmission configuration state set, the target reference signal resource is associated with the first function; if the first transmission configuration state does not belong to the first transmission configuration state set, the target reference signal resource is not associated with the first function; the first transmission configuration state set comprises at least one transmission configuration state.

In one subembodiment, the first transmission configuration state set is configured by RRC signaling.

In one embodiment, the first transmission configuration state indicates the third reference signal resource; if the third reference signal resource belongs to a first reference signal resource set, the target reference signal resource is associated with the first function; if the third reference signal resource does not belong to the first reference signal resource set, the target reference signal resource is not associated with the first function; the first reference signal resource set comprises at least one reference signal resource.

In one embodiment, the first transmission configuration state implicitly indicates whether the target reference signal resource is associated with the first enhancement function.

### Embodiment 16

Embodiment 16 illustrates a schematic diagram of a fifth information block indicating whether a target reference signal resource is suitable to be associated with a first function according to one embodiment of the present application; as shown in FIG. 16.

In one embodiment, the fifth information block is carried by an RRC signaling.

In one embodiment, the fifth information block is carried by a MAC CE.

In one embodiment, the fifth information block is carried by a physical layer.

In one embodiment, the fifth information block comprises a CRI.

In one embodiment, the fifth information block is earlier than the first information block in time domain.

In one embodiment, the fifth information block is used by a transmitter of the second information block to determine whether to indicate that the target reference signal resource is associated with the first function.

In one embodiment, the fifth information block indicates at least one reference signal resource suitable to be associated with the first function.

In one embodiment, the fifth information block indicates at least one reference signal resource not suitable to be associated with the first function.

In one embodiment, the fifth information block indicates at least one reference signal resource suitable for generating a compressed CSI.

In one embodiment, the fifth information block indicates at least one reference signal resource not suitable for generating a compressed CSI.

In one embodiment, the fifth information block indicates which reference signal resource(s) in the first reference signal resource sub-pool is(are) suitable to be associated with the first function.

In one embodiment, the fifth information block indicates which reference signal resource(s) in the first reference signal resource pool is(are) suitable to be associated with the first function.

In one embodiment, a measurement of a reference signal received in the target reference signal resource is used for generating a target pre-compression CSI, and the target pre-compression CSI is used as an input to the second function for generating a target compressed CSI, the target compressed CSI used as an input to the first function for generating a target CSI; the fifth information block indicates an error between the target CSI and the target pre-compression CSI.

In one subembodiment, the fifth information implicitly indicates whether the target reference signal resource is suitable to be associated with the first function via the error.

In one subembodiment, if the error is smaller than a first threshold, the target reference signal resource is suitable to be associated with the first function; if the error is larger than the first threshold, the target reference signal resource is not suitable to be associated with the first function.

In one subembodiment, a transmitter of the second information block determines whether to indicate that the target reference signal resource is associated with the first function according to the error.

In one embodiment, the fifth information block indicates whether the target reference signal resource is suitable to be associated with the first enhancement function.

In one embodiment, the fifth information block indicates which reference signal resource(s) in the first reference signal resource sub-pool is(are) suitable to be associated with the first enhancement function.

In one embodiment, the fifth information block indicates which reference signal resource(s) in the first reference signal resource pool is(are) suitable to be associated with the first enhancement function.

### Embodiment 17

Embodiment 17 illustrates a structure block diagram of a processing device in a first node according to one embodiment of the present application; as shown in FIG. 17. In FIG. 17, a processing device 1700 in a first node is comprised of a first processor 1701 and a first transmitter 1702.

In Embodiment 17, the first processor 1701 receives a reference signal in a first reference signal resource sub-pool, and determines a first function according to the receiving behavior in the first reference signal resource sub-pool, and receives a second information block; the first transmitter 1702 transmits a first information block and a third information block.

In Embodiment 17, the first reference signal resource sub-pool comprises at least one reference signal resource, and the first information block is used to determine the first function; the second information block is used to determine whether a target reference signal resource is associated with the first function; the third information block indicates a first compressed CSI, the first compressed CSI being an input to the first function for generating a first CSI.

In one embodiment, the first node is a UE; the first information block indicates the first function; the second information block indicates whether the target reference signal resource is associated with the first function; the first CSI comprises a first matrix, while the first compressed CSI comprises a second matrix, where a number of elements in the second matrix is less than a number of elements in the first matrix; a sixth information block indicates a first reference signal resource pool, and any reference signal resource in the first reference signal resource sub-pool belongs to the first reference signal resource pool, the first reference signal resource pool comprising at least one reference signal resource; the first node determines the first function according to a reference signal received in reference signal resource(s) in the first reference signal resource pool; the sixth information block indicates at least part of characteristics of the first function.

In one embodiment, the first processor 1701 determines a second function according to the receiving behavior in the first reference signal resource sub-pool; herein, an output of the second function comprises the first compressed CSI.

In one embodiment, the first transmitter 1702 transmits a fourth information block, the fourth information block indicating a second compressed CSI, the second compressed CSI being an input to a first enhancement function for generating a second CSI; herein, the first function is used for generating the first enhancement function; the second information block is used to determine whether the target reference signal resource is associated with the first enhancement function.

In one embodiment, the second information block indicates at least part of characteristics of the first function.

In one embodiment, the second information block indicates at least part of characteristics of the first enhancement function.

In one embodiment, the second information block comprises a first transmission configuration state, the first transmission configuration state implicitly indicating whether the target reference signal resource is associated with the first function.

In one embodiment, the first transmitter 1702 transmits a fifth information block, the fifth information block indicating whether the target reference signal resource is suitable to be associated with the first function.

In one embodiment, the first processor 1701 receives a reference signal in the target reference signal resource.

In one embodiment, the first node is a UE.

In one embodiment, the first node is a relay node.

In one embodiment, the first processor 1701 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1702 comprises at least one of the antenna 452, the transmitter 454, the transmitting processor 468, the multi-antenna transmitting processor 457, the controller/processor 459, the memory 460 or the data source 467 in Embodiment 4.

### Embodiment 18

Embodiment 18 illustrates a structure block diagram of a processing device in a second node according to one embodiment of the present application; as shown in FIG. 18. In FIG. 18, a processing device 1800 in a second node is comprised of a second transmitter 1801 and a first receiver 1802.

In Embodiment 18, the second transmitter 1801 transmits a reference signal in a first reference signal resource sub-pool and transmits a second information block; the first receiver 1802 receives a first information block and a third information block.

In Embodiment 18, the first reference signal resource sub-pool comprises at least one reference signal resource, and a target receiver of the first reference signal resource sub-pool determines a first function according to the receiving behavior in the first reference signal resource sub-pool; the first information block is used to determine the first function; the second information block is used to determine whether a target reference signal resource is associated with the first function; the third information block indicates a first compressed CSI, the first compressed CSI being an input to the first function for generating a first CSI.

In one embodiment, the second node is a base station; the first information block indicates the first function; the second information block indicates whether the target reference signal resource is associated with the first function; the first CSI comprises a first matrix, while the first compressed CSI comprises a second matrix, where a number of elements in the second matrix is less than a number of elements in the first matrix; a sixth information block indicates a first reference signal resource pool, and any reference signal resource in the first reference signal resource sub-pool belongs to the first reference signal resource pool, the first reference signal resource pool comprising at least one reference signal resource; the target receiver of the first reference signal resource sub-pool determines the first function according to a reference signal received in reference signal resource(s) in the first reference signal resource pool; the sixth information block indicates at least part of characteristics of the first function.

In one embodiment, the target receiver of the first reference signal resource sub-pool determines a second function according to the receiving behavior in the first reference signal resource sub-pool; herein, an output of the second function comprises the first compressed CSI.

In one embodiment, the first receiver 1802 receives a fourth information block, the fourth information block indicating a second compressed CSI, the second compressed CSI being an input to a first enhancement function for generating a second CSI; herein, the first function is used for generating the first enhancement function; the second information block is used to determine whether the target reference signal resource is associated with the first enhancement function.

In one embodiment, the second information block indicates at least part of characteristics of the first function.

In one embodiment, the second information block indicates at least part of characteristics of the first enhancement function.

In one embodiment, the second information block comprises a first transmission configuration state, the first transmission configuration state implicitly indicating whether the target reference signal resource is associated with the first function.

In one embodiment, the first receiver 1802 receives a fifth information block, the fifth information block indicating whether the target reference signal resource is suitable to be associated with the first function.

In one embodiment, the second transmitter 1801 transmits a reference signal in the target reference signal resource.

In one embodiment, the device in the second node is a base station.

In one embodiment, the device in the second node is a UE.

In one embodiment, the device in the second node is a relay node.

In one embodiment, the second transmitter 1801 comprises at least one of the antenna 420, the transmitter 418, the transmitting processor 416, the multi-antenna transmitting processor 471, the controller/processor 475 or the memory 476 in Embodiment 4.

In one embodiment, the first receiver 1802 comprises at least one of the antenna 420, the receiver 418, the receiving processor 470, the multi-antenna receiving processor 472, the controller/processor 475 or the memory 476 in Embodiment 4.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, vehicles, automobiles, RSU, wireless sensor, network cards, terminals for Internet of Things (IOT), RFID terminals, NB-IOT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, eNB, gNB, Transmitter Receiver Point (TRP), GNSS, relay satellite, satellite base station, airborne base station, Road Side Unit (RSU), drones, test equipment like transceiving device simulating partial functions of base station or signaling tester.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, characterized in comprising:
a first processor, which receives a reference signal in a first reference signal resource sub-pool, the first reference signal resource sub-pool comprising at least one reference signal resource, and determines a first function according to the receiving behavior in the first reference signal resource sub-pool; and
a first transmitter, which transmits a first information block, the first information block being used to determine the first function;
the first processor, which receives a second information block, the second information block being used to determine whether a target reference signal resource is associated with the first function;
the first transmitter, which transmits a third information block, the third information block indicating a first compressed CSI, the first compressed CSI being an input to the first function for generating a first CSI.

2. The first node according to claim 1, characterized in that the first processor determines a second function according to the receiving behavior in the first reference signal resource sub-pool; wherein an output by the second function comprises the first compressed CSI.

3. The first node according to claim 1, characterized in that the first transmitter transmits a fourth information block, the fourth information block indicating a second compressed CSI, the second compressed CSI being an input to a first enhancement function for generating a second CSI; wherein the first function is used for generating the first enhancement function; the second information block is used to determine whether the target reference signal resource is associated with the first enhancement function.

4. The first node according to claim 1, characterized in that the second information block indicates at least part of characteristics of the first function.

5. The first node according to claim 3, characterized in that the second information block indicates at least part of characteristics of the first enhancement function.

6. The first node according to claim 1, characterized in that the second information block comprises a first transmission configuration state, the first transmission configuration state implicitly indicating whether the target reference signal resource is associated with the first function.

7. The first node according to claim 1, characterized in that the first transmitter transmits a fifth information block, the fifth information block indicating whether the target reference signal resource is suitable to be associated with the first function.

8. A second node for wireless communications, characterized in comprising:
a second transmitter, which transmits a reference signal in a first reference signal resource sub-pool, the first reference signal resource sub-pool comprising at least one reference signal resource, and a target receiver of the first reference signal resource sub-pool determining a first function according to a receiving behavior in the first reference signal resource sub-pool; and
a first receiver, which receives a first information block, the first information block being used to determine the first function;
the second transmitter, which transmits a second information block, the second information block being used to determine whether a target reference signal resource is associated with the first function;
the first receiver, which receives a third information block, the third information block indicating a first compressed CSI, the first compressed CSI being an input to the first function for generating a first CSI.

9. The second node according to claim 8, characterized in that the target receiver of the first reference signal resource sub-pool determines a second function according to the receiving behavior in the first reference signal resource sub-pool; wherein an output by the second function comprises the first compressed CSI.

10. The second node according to claim 8, characterized in that the first receiver receives a fourth information block, the fourth information block indicating a second compressed CSI, the second compressed CSI being an input to a first enhancement function for generating a second CSI; wherein the first function is used for generating the first enhancement function; the second information block is used to determine whether the target reference signal resource is associated with the first enhancement function.

11. The second node according to claim 8, characterized in that the second information block indicates at least part of characteristics of the first function.

12. The second node according to claim 10, characterized in that the second information block indicates at least part of characteristics of the first enhancement function.

13. The second node according to claim 8, characterized in that the second information block comprises a first transmission configuration state, the first transmission configuration state implicitly indicating whether the target reference signal resource is associated with the first function.

14. The second node according to claim 8, characterized in that the first receiver receives a fifth information block, the fifth information block indicating whether the target reference signal resource is suitable to be associated with the first function.

15. A method in a first node for wireless communications, characterized in comprising:
receiving a reference signal in a first reference signal resource sub-pool, the first reference signal resource sub-pool comprising at least one reference signal resource; and
determining a first function according to the receiving behavior in the first reference signal resource sub-pool; and
transmitting a first information block, the first information block being used to determine the first function; and
receiving a second information block, the second information block being used to determine whether a target reference signal resource is associated with the first function; and
transmitting a third information block, the third information block indicating a first compressed CSI, the first compressed CSI being an input to the first function for generating a first CSI.

16. The method according to claim 15, characterized in comprising:
determining a second function according to the receiving behavior in the first reference signal resource sub-pool;
wherein an output by the second function comprises the first compressed CSI.

17. The method according to claim 15, characterized in comprising:
transmitting a fourth information block, the fourth information block indicating a second compressed CSI, the second compressed CSI being an input to a first enhancement function for generating a second CSI;
wherein the first function is used for generating the first enhancement function; the second information block is used to determine whether the target reference signal resource is associated with the first enhancement function.

18. The method according to claim 15, characterized in that the second information block indicates at least part of characteristics of the first function.

19. The method according to claim 15, characterized in that the second information block comprises a first transmission configuration state, the first transmission configuration state implicitly indicating whether the target reference signal resource is associated with the first function.

20. The method according to claim 15, characterized in comprising:
transmitting a fifth information block, the fifth information block indicating whether the target reference signal resource is suitable to be associated with the first function.
